(19) United States
(12) Patent Application Publication
(10) Pub. No.: US 2018/0019994 A1
(43) Pub. Date: Jan. 18, 2018

(54) METHOD OF AUTHENTICATING USER AND ELECTRONIC DEVICE SUPPORTING THE SAME

(71) Applicant: Samsung Electronics Co., Ltd., Suwon-si (KR)

(72) Inventors: Moon Soo CHANG, Yongin-si (KR); Min Ho KIM, Suwon-si (KR); Jong Hoon PARK, Suwon-si (KR); In Jun SON, Suwon-si (KR); In Myung CHOI, Suwon-si (KR); Ji Yoon PARK, Yongin-si (KR); Dong Hyun YEOM, Bucheon-si (KR)

(21) Appl. No.: 15/649,013

(22) Filed: Jul. 13, 2017

(30) Foreign Application Priority Data
Jul. 18, 2016 (KR) 10-2016-0091018

(51) Int. Cl. H04L 29/06; G06F 21/45; G06F 21/32

(52) U.S. Cl. CPC H04L 63/0838; H04L 63/0861; G06F 21/32; G06F 21/45

(57) ABSTRACT

An electronic device is provided. The electronic device includes a sensor configured to sense a part of a body of a user, a memory, and at least one processor operatively connected with the sensor and the memory. The at least one processor is configured to acquire at least one piece of first bio-information related to the part of the body of the user through the sensor, create at least one piece of identification (ID) information based on the at least one piece of first bio-information, set at least one of at least one key value or at least one parameter value used for generating at least one one-time password (OTP) by using the at least one piece of ID information, generate the at least one OTP by using the at least one key value and the at least one parameter value, and transmit the at least one OTP to at least one external device.

### CROSS-REFERENCE TO RELATED APPLICATION(S)

This application claims the benefit under 35 U.S.C. §119(a) of a Korean patent application filed on Jul. 18, 2016 in the Korean Intellectual Property Office and assigned Serial number 10-2016-0091018, the entire disclosure of which is hereby incorporated by reference.

### TECHNICAL FIELD

The present disclosure relates to a method of authenticating a user and an electronic device supporting the same.

### BACKGROUND

An electronic device, such as a smart phone, may provide a user with a service, such as a financial transaction that requires a high-level security. For example, the electronic device may provide the user with an environment which is able to execute an application (e.g., a bank application) related to the financial transaction.

The electronic device may perform a procedure of authenticating the user, in the case of transmitting security information (e.g. user information or financial transaction information, to an external electronic device such that the security information is prevented from carelessly leaking out when the electronic device provides the service requiring the high-level security. For example, the electronic device may provide the user with an interface for inputting a pin code or a password, and the user may input the set pin code or password, thereby authenticating him or her.

The electronic device may support the user such that the user uses a one-time password (OTP), which is a disposable password, to complement the pin code or the password. The pin code or the password may leak out, and the user has to memorize the set pin code or the password. To the contrary, the OTP, which is a disposable password, is generated at every time and is provided for the user, and the user inputs the generated OTP to perform a procedure of authenticating the user. Accordingly, the OTP may prevent the password from leaking out and may complement a disadvantage of the password that the user has to memorize.

However, in the case that a seed value of the OTP, which is stored in the electronic device and an authentication server in common, leaks out, even though a user is not a genuine user, the user may easily use the OTP. Even if a user uses an OTP, since the user has to still input the generated OTP, the user may feel inconvenient in the use of the OTP.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of present disclosure is to provide methods of authenticating users by using one-time passwords (OTPs) generated based on user authentication information (e.g., bio-information) and electronic devices supporting the same.

In accordance with an aspect of the present disclosure, an electronic device is provided. The electronic device includes a sensor configured to sense a part of a body of a user, a memory, and at least one processor operatively connected with the sensor and the memory. The at least one processor is configured to acquire at least one piece of first bio-information related to the part of the body of the user through the sensor, create at least one piece of identification (ID) information based on the at least one piece of first bio-information, set at least one of at least one key value or at least one parameter value used for generating at least one OTP by using the at least one piece of ID information, generate the at least one OTP by using the at least one key value and the at least one parameter value, and transmit the at least one OTP to at least one external device.

In accordance with another aspect of the present disclosure, a method of authenticating a user by an electronic device is provided. The method includes acquiring at least one piece of first bio-information related to a part of a body of the user through a sensor, creating at least one piece of ID information based on the at least one piece of the first bio-information, setting at least one of at least one key value or at least one parameter value used for generating at least one OTP by using the at least one piece of ID information, generating the at least one OTP by using the at least one key value and the at least one parameter value, and transmitting the at least one OTP to at least one external device.

In accordance with another aspect of the present disclosure, an electronic device is provided. The electronic device includes a housing, a display that is exposed through one surface of the housing, a biometric sensor mounted in a portion of the housing, a wireless communication circuit, at least one processor electrically connected with the display, the biometric sensor, and the wireless communication circuit, and a memory electrically connected with the processor and configured to store bio-information of a user. The memory stores instructions that, when executed, cause the at least one processor to acquire first bio-information of the user by using the biometric sensor, compare the first bio-information with second bio-information which is stored in the memory, select or create first information based on a comparison result, generate a number based on the first information, second information related to the electronic device, and time information, transmit the number to an external server through the wireless communication circuit, and receive a response related to the number from the external server through the wireless communication circuit.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view illustrating an electronic device in a network environment 100 according to an embodiment of the present disclosure.

FIG. 2 is a block diagram of a security processing module according to an embodiment of the present disclosure.

FIG. 3 is a diagram illustrating an operating method of an electronic device associated with a method of authenticating a user according to an embodiment of the present disclosure.

FIG. 4A is a view illustrating a setting of a one-time password (OTP), according to an embodiment of the present disclosure.

FIG. 4B is a view illustrating another setting of an OTP according to an embodiment of the present disclosure.

FIG. 5 is a view illustrating a method of authenticating a user by using an OTP according to an embodiment of the present disclosure.

FIG. 6A is a view illustrating generating of an OTP value according to an embodiment of the present disclosure.

FIG. 6B is a view illustrating another generating of an OTP value according to an embodiment of the present disclosure.

FIG. 7A is a view illustrating generating of an OTP value corresponding to each of multiple pieces of bio-information according to an embodiment of the present disclosure.

FIG. 7B is a view illustrating generating of OTP values using one piece of bio-information according to an embodiment of the present disclosure.

FIG. 8 is a view illustrating generating of an OTP value by using multiple pieces of bio-information according to an embodiment of the present disclosure.

FIG. 9A is a view illustrating a screen to describe a method of authenticating a user through fingerprint recognition according to an embodiment of the present disclosure.

FIG. 9B is a view illustrating a screen to describe a method of authenticating a user through iris recognition according to an embodiment of the present disclosure.

FIG. 10 is a block diagram illustrating an electronic device according to an embodiment of the present disclosure.

FIG. 11 is a block diagram illustrating a program module according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include,” “comprise,” and “have”, or “may include,” or “may comprise” and “may have” used herein indicates disclosed functions, operations, or existence of elements but does not exclude other functions, operations or elements.

For example, the expressions “A or B,” or “at least one of A and/or B” may indicate A and B, A, or B. For instance, the expression “A or B” or “at least one of A and/or B” may indicate (1) at least one A, (2) at least one B, or (3) both at least one A and at least one B.

The terms such as “1st,” “2nd,” “first,” “second,” and the like used herein may refer to modifying various different elements of various embodiments of the present disclosure, but are not intended to limit the elements. For instance, “a first user device” and “a second user device” may indicate different users regardless of order or importance. For example, a first component may be referred to as a second component and vice versa without departing from the scope and spirit of the present disclosure.

In various embodiments of the present disclosure, it is intended that when a component (e.g., a first component) is referred to as being “operatively or communicatively coupled with/to” or “connected to” another component (e.g., a second component), the component may be directly connected to the other component or connected through another component (e.g., a third component). In various embodiments of the present disclosure, it is intended that when a component (e.g., a first component) is referred to as being “directly connected to” or “directly accessed” another component (e.g., a second component), another component (e.g., a third component) does not exist between the component (e.g., the first component) and the other component (e.g., the second component).

The expression “configured to” used in various embodiments of the present disclosure may be interchangeably used with “suitable for,” “having the capacity to,” “designed to,” “adapted to,” “made to,” or “capable of” according to the situation, for example. The term “configured to” may not necessarily indicate “specifically designed to” in terms of hardware. Instead, the expression “a device configured to” in some situations may indicate that the device and another device or part are “capable of.” For example, the expression “a processor configured to perform A, B, and C” may indicate a dedicated processor (e.g., an embedded processor) for performing a corresponding operation or a general purpose processor (e.g., a central processing unit (CPU) or application processor (AP)) for performing corresponding operations by executing at least one software program stored in a memory device.

All terms used herein may have the same meanings that are generally understood by a person skilled in the art. In general, terms defined in a dictionary should be considered to have the same meanings as the contextual meaning of the related art, and, unless clearly defined herein, should not be understood differently or as having an excessively formal meaning. In any case, even the terms defined in the present specification are not intended to be interpreted as excluding various embodiments of the present disclosure.

An electronic device according to various embodiments of the present disclosure may include at least one of a smartphone, a tablet personal computer (PC), a mobile phone, a video telephone, an electronic book reader, a desktop PC, a laptop PC, a netbook computer, a workstation, a server, a personal digital assistant (PDA), a portable multimedia player (PMP), a Moving Picture Experts Group (MPEG-1 or MPEG-2) audio layer 3 (MP3) player, a mobile medical device, a camera, or a wearable device. The wearable device may include at least one of an accessory-type device (e.g., a watch, a ring, a bracelet, an anklet, a necklace, glasses, a contact lens, a head-mounted device (HMD)), a textile- or clothing-integrated-type device (e.g., an electronic apparel), a body-attached-type device (e.g., a skin pad or a tattoo), or a bio-implantable-type device (e.g., an implantable circuit)

In some various embodiments of the present disclosure, an electronic device may be a home appliance. The smart home appliance may include at least one of, for example, a television (TV), a digital video/versatile disc (DVD) player, an audio, a refrigerator, an air conditioner, a cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ or PlayStation™), an electronic dictionary, an electronic key, a camcorder, or an electronic picture frame.

In other various embodiments of the present disclosure, an electronic device may include at least one of various medical devices (e.g., various portable medical measurement devices (e.g., a blood glucose measuring device, a heart rate measuring device, a blood pressure measuring device, a body temperature measuring device, or the like), a magnetic resonance angiography (MRA), a magnetic resonance imaging (MRI), a computed tomography (CT), a scanner, an ultrasonic device, or the like), a navigation device, a global navigation satellite system (GNSS), an event data recorder (EDR), a flight data recorder (FDR), a vehicle infotainment device, electronic equipment for vessels (e.g., a navigation system, a gyrocompass, or the like), avionics, a security device, a head unit for a vehicle, an industrial or home robot, an automatic teller machine (ATM), a point of sales (POS) device of a store, or an Internet of things (IoT) device (e.g., a light bulb, various sensors, an electric or gas meter, a sprinkler, a fire alarm, a thermostat, a streetlamp, a toaster, exercise equipment, a hot water tank, a heater, a boiler, or the like).

According to various embodiments of the present disclosure, an electronic device may include at least one of a part of furniture or a building/structure, an electronic board, an electronic signature receiving device, a projector, or a measuring instrument (e.g., a water meter, an electricity meter, a gas meter, a wave meter, or the like). An electronic device may be one or more combinations of the above-mentioned devices. An electronic device according to some various embodiments of the present disclosure may be a flexible device. An electronic device according to an embodiment of the present disclosure is not limited to the above-mentioned devices, and may include new electronic devices with the development of new technology.

Hereinafter, an electronic device according to various embodiments of the present disclosure will be described in more detail with reference to the accompanying drawings. The term “user” used herein may refer to a person who uses an electronic device or may refer to a device (e.g., an artificial intelligence electronic device) that uses an electronic device.

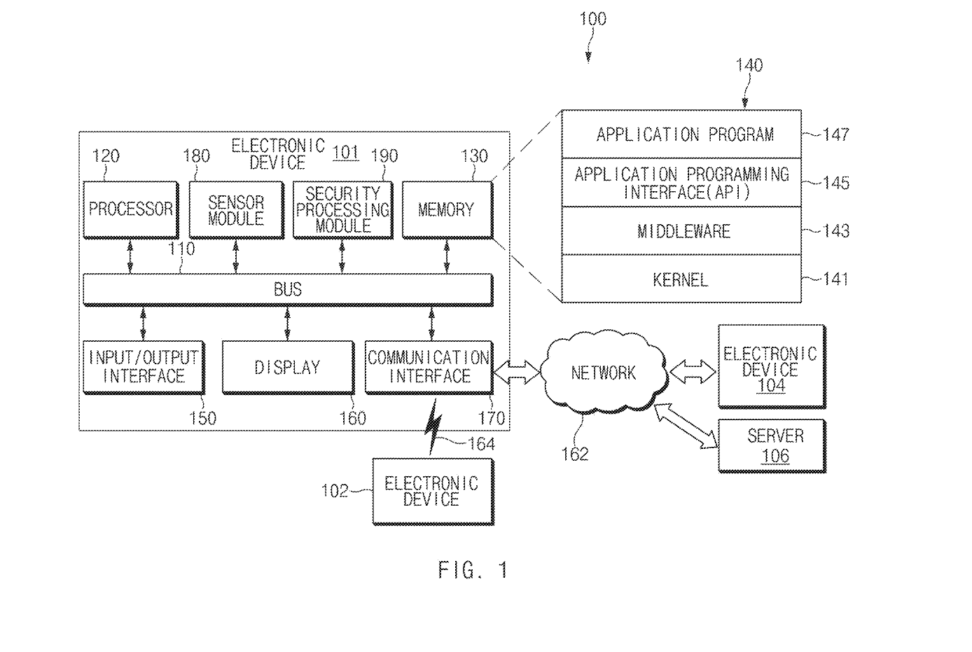

FIG. 1 is a view illustrating an electronic device in a network environment according to an embodiment of the present disclosure.

Referring to FIG. 1, according to various embodiments, an electronic device 101 in a network environment 100 may provide a service, such as financial services, requiring high-level security. The electronic device 101 may perform a procedure of authenticating a user when transmitting security information, which is user information or financial transaction information, to an external device (e.g., a first external electronic device 102, a second external electronic device 104, or a server 106) such that the security information is prevented from being leak out when the service is provided. According to an embodiment, the electronic device 101 may generate a one-time password (OTP), which is a disposable password, at every time to provide a user with the OTP. The user may proceed with the procedure of authenticating the user by inputting the generated OTP.

For example, an OTP may be generated by employing a seed value, which is produced based on identification (ID) information of the electronic device 101, as a key value and computing the key value together with a parameter value, such as time information (e.g., current time), in an algorithm such as a hash function. Since the same seed value is stored in the electronic device 101 and an OTP authentication server (e.g., the server 106), as the same parameter value, such as the time information, is employed, OTP values generated in the electronic device 101 and the OTP authentication server may correspond to each other as equal values.

The electronic device 101 may generate the OTP based on the user authentication information. For example, the electronic device 101 may generate the OTP based on bio-information (e.g., fingerprint information, iris information, face information, heart rate information, voice information, and blood vessel information) of the user or information (e.g., a password, a pin code, or a pattern) set by the user, thereby ensuring the reliability in the procedure of authenticating the user using the OTP.

Referring to FIG. 1, according to various embodiments, the electronic device 101 may be connected with the external device (e.g., the first external electronic device 102, the second external electronic device 104, or the server 106) through a network 162 or a short-range communications 164. The electronic device 101 may include a bus 110, a processor 120, a memory 130, an input/output (I/O) interface 150, a display 160, a communication interface 170, a sensor module 180, and a security processing module 190. According to an embodiment, the electronic device 101 may not include at least one of the elements or may further include any other elements(s).

The bus 110 may include a circuit for connecting the above-mentioned elements 110, 120, 130, 150, 160, 170 and 180 to each other and transferring communications (e.g., control messages and/or data) among the above-mentioned elements.

The processor 120 may include at least one of a CPU, an AP, or a communication processor (CP). The processor 120 may perform data processing or an operation related to communication and/or control of at least one of the other elements of the electronic device 101.

The memory 130 may include a volatile memory and/or a nonvolatile memory. The memory 130 may store instructions or data related to at least one of the other elements of the electronic device 101. According to an embodiment of the present disclosure, the memory 130 may store software and/or a program 140. The program 140 may include, for example, a kernel 141, a middleware 143, an application programming interface (API) 145, and/or an application program (or an application) 147. At least a portion of the kernel 141, the middleware 143, or the API 145 may be referred to as an operating system (OS).

The kernel 141 may control or manage system resources (e.g., the bus 110, the processor 120, the memory 130, or the like) used to perform operations or functions of other programs (e.g., the middleware 143, the API 145, or the application program 147). Furthermore, the kernel 141 may provide an interface for allowing the middleware 143, the API 145, or the application program 147 to access individual elements of the electronic device 101 in order to control or manage the system resources.

The middleware 143 may serve as an intermediary so that the API 145 or the application program 147 communicates and exchanges data with the kernel 141.

Furthermore, the middleware 143 may handle one or more task requests received from the application program 147 according to a priority order. For example, the middleware 143 may assign at least one application program 147 a priority for using the system resources (e.g., the bus 110, the processor 120, the memory 130, or the like) of the electronic device 101. For example, the middleware 143 may handle the one or more task requests according to the priority assigned to the at least one application, thereby performing scheduling or load balancing with respect to the one or more task requests.

The API 145, which is an interface for allowing the application 147 to control a function provided by the kernel 141 or the middleware 143, may include, for example, at least one interface or function (e.g., instructions) for file control, window control, image processing, character control, or the like.

According to an embodiment, the memory 130 may store at least one of a seed value, the user authentication information, and ID information (e.g., an ID number) of the user authentication information, which are used for an OTP. The seed value may be a basic value used to generate an OTP value and may be set to a value corresponding to the ID information of the electronic device 101. For example, the electronic device 101 may transmit at least one of ID information of the electronic device 101, certificate information, which is created based on at least one of the ID information of the electronic device 101 and user information (e.g., user personal information such as a name or an ID), and user signature information, to the OTP authentication server (e.g., the server 106). The OTP authentication server may set the seed value to a value corresponding to at least one of the ID information of the electronic device 101, the certificate information, and the user signature information and may transmit the seed value to the electronic device 101.

The user authentication information, which serves as inherent information on the user, may include, for example, the bio-information, such as the, fingerprint information, the iris information, the face information, the heart rate information, the voice information, or the blood vessel information, of the user or the information, such as the password, a pin code, or a pattern, set by the user. For example, the bio-information may be acquired from the user through the sensor module 180. Alternatively, the bio-information may be acquired from the external device (e.g., the first external electronic device 102, the second external electronic device 104, or the server 106) through the communication interface 170.

The ID information (e.g., the ID number) of the user authentication information may correspond to the user ID information and may be set to a different value for each piece of user authentication information. For example, the fingerprint information may be mapped to first ID information, and the iris information may be mapped to second ID information. In addition, the electronic device 101 may map fingerprint information acquired from each finger of the user to different ID information. According to an embodiment, the electronic device 101 may map multiple pieces of bio-information of the user to one piece of ID information. In other words, the electronic device 101 may map the fingerprint information and the iris information of the user to one piece of ID information.

The I/O interface 150 may serve to transfer an instruction or data input from a user or another external device to (an)other element(s) of the electronic device 101. Furthermore, the I/O interface 150 may output instructions or data received from (an)other element(s) of the electronic device 101 to the user or another external device.

The display 160 may include, for example, a liquid crystal display (LCD), a light-emitting diode (LED) display, an organic LED (OLED) display, a microelectromechanical systems (MEMS) display, or an electronic paper display. The display 160 may present various content (e.g., a text, an image, a video, an icon, a symbol, and the like) to the user. The display 160 may include a touch screen, and may receive a touch, gesture, proximity or hovering input from an electronic pen or a part of a body of the user.

The communication interface 170 may set communications between the electronic device 101 and an external device (e.g., the first external electronic device 102, the second external electronic device 104, or the server 106). For example, the communication interface 170 may be connected to a network 162 via wireless communications or wired communications so as to communicate with the external device (e.g., the second external electronic device 104 or the server 106).

The wireless communications may employ at least one of cellular communication protocols such as long-term evolution (LTE), LTE-advance (LTE-A), code division multiple access (CDMA), wideband CDMA (WCDMA), universal mobile telecommunications system (UMTS), wireless broadband (WiBro), or global system for mobile communications (GSM). The wireless communications may include, for example, the short-range communications 164. The short-range communications 164 may include at least one of Wi-Fi, Bluetooth (BT), near field communication (NFC), magnetic stripe transmission (MST), or GNSS.

The MST may generate pulses according to transmission data and the pulses may generate electromagnetic signals. The electronic device 101 may transmit the electromagnetic signals to a reader device such as a POS (point of sales) device. The POS device may detect the magnetic signals by using a MST reader and restore data by converting the detected electromagnetic signals into electrical signals.

The GNSS may include, for example, at least one of global positioning system (GPS), global navigation satellite system (GLONASS), BeiDou navigation satellite system (BeiDou), or Galileo, the European global satellite-based navigation system according to a use area or a bandwidth. Hereinafter, the term “GPS” and the term “GNSS” may be interchangeably used. The wired communications may include at least one of universal serial bus (USB), high definition multimedia interface (HDMI), recommended standard 232 (RS-232), plain old telephone service (POTS), or the like. The network 162 may include at least one of telecommunications networks, for example, a computer network (e.g., local area network (LAN) or wide area network (WAN)), the Internet, or a telephone network.

The types of the first external electronic device 102 and the second external electronic device 104 may be the same as or different from the type of the electronic device 101. According to an embodiment of the present disclosure, the server 106 may include a group of one or more servers. A portion or all of operations performed in the electronic device 101 may be performed in one or more other electronic devices (e.g., the first external electronic device 102, the second external electronic device 104, or the server 106). When the electronic device 101 should perform a certain function or service automatically or in response to a request, the electronic device 101 may request at least a portion of functions related to the function or service from another device (e.g., the first external electronic device 102, the second external electronic device 104, or the server 106) instead of or in addition to performing the function or service for itself. The other electronic device (e.g., the first external electronic device 102, the second external electronic device 104, or the server 106) may perform the requested function or additional function, and may transfer a result of the performance to the electronic device 101. The electronic device 101 may use a received result itself or additionally process the received result to provide the requested function or service. To this end, for example, a cloud computing technology, a distributed computing technology, or a client-server computing technology may be used.

The sensor module 180 may recognize the body of the user. For example, the sensor module 180 may include a fingerprint recognition sensor, an iris recognition sensor, a face recognition sensor, a heart rate sensor, a voice recognition sensor, or a blood vessel recognition sensor. The fingerprint recognition sensor may recognize the fingerprint of the user in a line scan manner or an area scan manner. For example, the fingerprint recognition sensor may acquire fingerprint information if the user swipes or touches a sensing area of the fingerprint recognition sensor. The fingerprint recognition sensor may employ an optical, capacitive, or ultrasonic manner. The optical manner for the fingerprint recognition sensor is to irradiate a finger with light and to collect fingerprint images using reflected light. The capacitive manner of the fingerprint recognition sensor is to collect the fingerprint images by using the capacitance difference made as the finger touches or approaches the fingerprint recognition sensor. The ultrasonic manner for the fingerprint recognition sensor is to apply an ultrasonic wave to the finger and to collect the fingerprint images by using the reflective ultrasonic wave.

The iris recognition sensor may recognize the iris of the user by using an iris camera (e.g., an infrared camera). In other words, the iris recognition sensor may irradiate the eye of the user with infrared light and may analyze the reflected infrared light to recognize the iris of the user. For example, the iris recognition sensor may detect the iris of the user by scanning for the boundary between a pupil and the iris, which greatly represents the change in color or contrast around the pupil having the darkest color in the eye of the user. In addition, the iris recognition sensor may recognize the iris by detecting the boundary with a sclera surrounding an outer portion of the iris.

The face recognition sensor may recognize the face of the user by analyzing an image of the face captured through a camera. In other words, the face recognition sensor may extract the facial area from the image and may determine whether the face of the user is the face of a genuine user. For example, the face recognition sensor may extract the facial area of the user by extracting the brightness difference, the color difference or features of the face from the image such that the face is distinguished from a background. The face recognition sensor may recognize the face of the user by comparing data (e.g., pixel values) of the extracted facial area with facial data of the user which is previously stored.

The heart rate sensor may irradiate the finger of the user with light using a light emitting diode (LED) and may measure quantity of reflected light according to the flow rate of blood flowing along a blood vessel of the finger, thereby measuring the heart rate of the user. The heart rate sensor may convert the variation in the quantity of the reflected light into an electrical signal and may analyze a variation pattern of the electrical signal, thereby calculating the heart rate of the user.

The voice recognition sensor may analyze voice acquired through a microphone and may recognize the voice of the user. For example, the voice recognition sensor may remove a noise component from the voice and may extract the inherent feature, such as a pronunciation or an intonation, of the user, thereby recognizing the voice of the user.

The blood vessel recognition sensor may irradiate light the finger of the user with light by using an LED and may measure reflected light or transmitted light to determine the position of a blood vessel (e.g., a vein) or the shape of the blood vessel, thereby recognizing the blood vessel of the user.

According to an embodiment, the sensor module 180 may store collected bio-information, in detail, fingerprint information, iris information, face information, heart rate information, voice information, or blood vessel information into the memory 130. The sensor module 180 may notify the processor 120 or the security processing module 190 of the fact that the bio-information has been collected.

The security processing module 190 may authenticate the user by using the collected bio-information. For example, the security processing module 190 may analyze fingerprint information, iris information, face information, heart rate information, voice information, or blood vessel information, which is stored in the memory 130 and may determine whether the fingerprint information, the iris information, the face information, the heart rate information, the voice information, or the blood vessel information is the bio-information of the user. In this case, the security processing module 190 may use bio-information previously stored in the memory 130 or a security area (e.g., a trust zone) in the procedure of registering the bio-information. In detail, the security processing module 190 may acquire bio-information, which is registered by the genuine user, from the memory 130 to compare the registered bio-information with the bio-information acquired from the sensor module 180. The security processing module 190 may authenticate the user if the acquired bio-information is identical to or similar to the registered bio-information.

According to an embodiment, the security processing module 190 may detect a curve pattern of a fingerprint and may analyze fingerprint information on the lengths or directions of ridges included in the fingerprint, or specific points (e.g., bifurcations, crossover points, or ending points of the ridges) of the ridges. In addition, the security processing module 190 may determine, based on the analysis result of the fingerprint information, a location relationship with multiple pieces of fingerprint information which is previously collected and registered. The security processing module 190 may determine the location relationship of the fingerprint information, may calculate spatial information (e.g., location information), or may detect the feature of the curve pattern of the fingerprint. In addition, the security processing module 190 may analyze a frequency component. For example, the security processing module 190 may analyze the frequency component of the collected fingerprint information in an algorithm such as a fast Fourier transform (FFT) algorithm.

According to an embodiment, the security processing module 190 may make coordinates with respect to data corresponding to an iris area (e.g., an area from the boundary between the iris and the pupil to the boundary between the iris and the sclera) and may binarize an iris pattern to express the iris pattern in number of “0” and “1” such that the binarized code string is compared with iris information (e.g., iris code string) previously stored in the memory 130.

The security processing module 190 may create ID information corresponding to the user authentication information (e.g., bio-information). For example, the security processing module 190 may create ID information (biometric ID) to distinguish among the fingerprint information, the iris information, the face information, the heart rate information, the voice information, or the blood vessel information. For example, when the user registers the bio-information, the security processing module 190 may create a biometric ID for each registered bio-information. The biometric ID may be created in various manners. For example, the security processing module 190 may create, as the biometric ID, a hash value which is produced as a numeric-string code corresponding to the bio-information is used as an input value of a hash function. Even in the case of the same bio-information, the security processing module 190 may create multiple biometric IDs, which are different from each other, by varying the number of times that the hash function is applied.

The security processing module 190 may map the created biometric ID to the user authentication information (e.g., bio-information) corresponding to the created biometric ID and may store the created biometric ID and the user authentication information in the memory 130 on the basis of the mapping result. For example, the security processing module 190 may map one biometric ID to one bio-information corresponding to the biometric ID and may store the biometric ID the bio-information in the memory 130 on the basis of the mapping result. Alternatively, the security processing module 190 may map one bio-information to multiple biometric IDs corresponding to the bio-information and may store the bio-information and the multiple biometric IDs in the memory 130 on the basis of the mapping result. In addition, even in the case of multiple pieces of bio-information, if the multiple pieces of bio-information belong to the same user, the security processing module 190 may map the multiple pieces of bio-information to representative one of biometric IDs corresponding to the multiple pieces of bio-information and may store the bio-information and the representative biometric ID in the memory 130 on the basis of the mapping result.

If the user authentication is completed using the user authentication information, the security processing module 190 may generate an OTP using the biometric ID corresponding to the user authentication information. The security processing module 190 may generate an OTP value by using a key value (e.g., a secret key value) and a parameter value (or a salt value). According to an embodiment, the security processing module 190 may set the key value to the seed value. According to an embodiment, the security processing module 190 may process the biometric ID corresponding to the user information and the seed value in a specified algorithm and may set the key value to a value obtained through the processing of the algorithm. According to an embodiment, the security processing module 190 may set the parameter value to time information (e.g., current time) of the electronic device 101 for the time synchronization when generating the OTP value. According to an embodiment, the security processing module 190 may perform an operation for the biometric ID and the time information and may set the parameter value to a value obtained through the operation processing. According to an embodiment, the security processing module 190 may register information (e.g., an OTP seed value) related to the OTP while storing the bio-information in the procedure of registering the bio-information.

The security processing module 190 may transmit the generated OTP value to the external device (e.g., the first external electronic device 102, the second external electronic device 104, or the server 106). For example, the security processing module 190 may transmit the generated OTP value to a providing server of a service such as financial services. The service providing server may transmit the received OPT value to an OTP authentication server to determine whether the OTP value is generated by using the key value and the parameter value corresponding to the authenticated user. In addition, the security processing module 190 may directly transmit the generated OTP value to the OTP authentication server, which is linked to the service providing server, instead of transmitting the generated OTP value to the service providing server. In this case, the OTP authentication server may determine whether the OTP value is correct and may notify the determination result to the service providing server.

According to an embodiment, the security processing module 190 may control a relevant module to provide an interface for user authentication before the security information is transmitted to the external device, if there occurs the situation that the security information is transmitted to the external device (e.g., the service providing server). For example, the security processing module 190 may display a relevant screen on the display 160 such that the bio-information is input to generate the OTP value. In detail, the security processing module 190 may control the display 160 to display a screen including a text or an image for allowing a user to approach the sensing area of the sensor module 180 with the finger, the eye, the face, or the wrist of the user or to input the voice of the user. The security processing module 190 may output, through a voice output device included in the I/O interface 150, voice for allowing the user to approach the sensing area of the sensor module 180 with the finger, the eye, the face, or the wrist of the user or to input the voice of the user.

According to an embodiment, the security processing module 190 may be configured in the form independent from the processor 120. According to an embodiment, the security processing module 190 may be configured in the form included in the processor 120. Even if the security processing module 190 is configured in the form independent from the processor 120, the security processing module 190 may be controlled by the processor 120 when executing at least a portion of the functions of the security processing module 190 and/or operations or data related to communication may be processed by the processor 120.

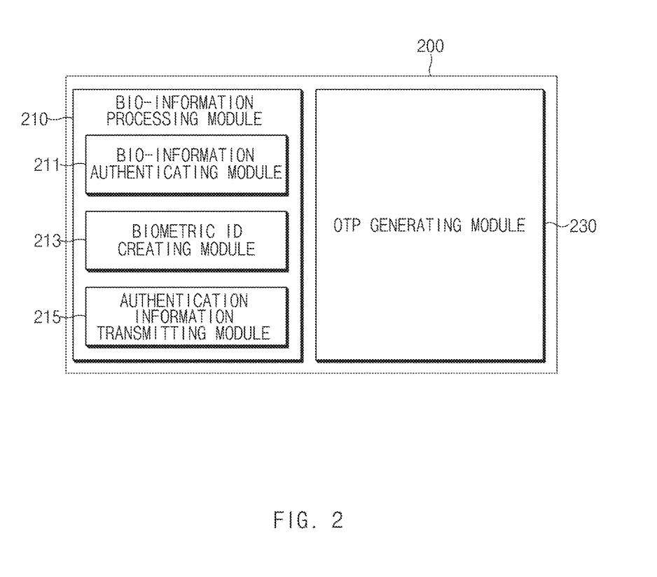

FIG. 2 is a block diagram of a security processing module according to an embodiment of the present disclosure.

Referring to FIG. 2, according to various embodiments of the present disclosure, a security processing module 200 may include a bio-information processing module 210 or an OTP generating module 230. The bio-information processing module 210 may process the authentication of bio-information, the creation of a biometric ID corresponding to the bio-information, or the transmission of the authentication information necessary for authenticating a user. The OTP generating module 230 may generate an OTP value.

According to various embodiments of the present disclosure, the bio-information processing module 210 may include a bio-information authenticating module 211, a biometric ID creating module 213, or an authentication information transmitting module 215. The bio-information authenticating module 211 may authenticate bio-information acquired from a sensor module (e.g., the sensor module 180) or bio-information acquired from the external device (e.g., the first external electronic device 102, the second external electronic device 104, or the server 106) through the communication interface 170. For example, the bio-information authenticating module 211 may determine whether the acquired bio-information is bio-information of a registered user. In detail, the bio-information authenticating module 211 may compare the acquired bio-information with bio-information which is previously stored in a memory (e.g., the memory 130) and may determine the acquired bio-information as bio-information of an authenticated user if the acquired bio-information is identical to or similar to the previously-stored bio-information.

According to various embodiments of the present disclosure, the biometric ID creating module 213 may create a biometric ID corresponding to bio-information. For example, the biometric ID creating module 213 may create a biometric ID for each registered bio-information. In detail, the biometric ID creating module 213 may create a first biometric ID, a second biometric ID, and a third biometric ID corresponding to first bio-information (e.g., fingerprint information of a right thumb), second bio-information (e.g., fingerprint information of a left thumb), and third bio-information (e.g., iris information), respectively. In addition, the biometric ID creating module 213 may create multiple biometric IDs corresponding to one piece of bio-information. In detail, the biometric ID creating module 213 may create the first biometric ID, the second biometric ID, and the third biometric ID corresponding to the first bio-information. In addition, the biometric ID creating module 213 may create one biometric ID corresponding to multiple pieces of bio-information of the user. In detail, the biometric ID creating module 213 may create one fourth biometric ID corresponding to the first bio-information, the second bio-information, and the third bio-information of the user. In addition, the biometric ID creating module 213 may create the first biometric ID, the second biometric ID, and the third biometric ID corresponding to the first bio-information, the second bio-information, and the third bio-information, respectively, and may map the first to third biometric IDs to the fourth biometric ID.

According to an embodiment, the biometric ID creating module 213 may employ, as a biometric ID of bio-information, a hash value which is produced as a numeric-string code corresponding to the bio-information is used as an input value of a hash function. In addition, the biometric ID creating module 213 may create biometric IDs, which are different from each other, by varying the number of times that the hash function is applied. However, the scheme of creating the biometric ID is not limited thereto. The biometric ID creating module 213 may map the created biometric ID to the bio-information corresponding to the biometric ID and may store the created biometric ID and the bio-information in the memory 130 on the basis of the mapping result.

According to various embodiments of the present disclosure, the authentication information transmitting module 215 may transmit authentication information used for user authentication to the authentication server (e.g., the server 106). For example, the authentication information transmitting module 215 may transmit at least one biometric ID of an electronic device (e.g., the electronic device 101), certificate information, or user signature information to the OTP authentication server (e.g., server 106). The biometric ID of the electronic device may include, for example, a serial number or a phone number of the electronic device. The certificate information may be, for example, information related to a certificate created based on at least one biometric ID of the electronic device and user information (e.g., personal information of the user including a name or an ID of the user) and may be acquired from the authentication server. The certificate information may include data on the certificate, information (e.g., the information on a user permitted in the use of the certificate or the expiration date of the certificate) on the user authority of the certificate or information on an authentication server issuing the certificate. The user signature information may include ID information of the user. For example, the user signature information may be used to identify a user who is permitted in the use of the certificate.

Alternatively, the authentication information transmitting module 215 may transmit the OTP value, which is generated through the OTP generating module 230, to the service providing server or the OTP authentication server. The authentication information transmitting module 215 may transmit at least one biometric ID used for the generation of the OTP value or the user signature information together with the generated OTP value.

According to various embodiments of the present disclosure, if the authentication information is transmitted to the authentication server, the authentication server may transmit the authentication result to the security processing module 200. For example, the OTP authentication server may transmit a seed value, which is produced based on at least one of the biometric ID of the electronic device, the certificate information, or the user signature information, to the security processing module 200. In this case, the security processing module 200 may store the seed value in a memory (e.g., the memory 130) and may generate the OPT value by using the seed value. Alternatively, the service providing server or the OTP authentication server may transmit, to the security processing module 200, the determination result of whether the OPT value is generated based on a key value (e.g., the seed value) or a parameter value corresponding to an authenticated user.

According to various embodiments of the present disclosure, the OTP generating module 230 may generate the OTP value by using at least one of the seed value, the biometric ID, or the time information (e.g., current time) of the electronic device. According to an embodiment, if the acquired bio-information is determined as the bio-information of the authenticated user, the OTP generating module 230 may generate the OTP value by using at least one of the biometric ID corresponding to the acquired bio-information, the seed value, or the time information of the electronic device.

According to an embodiment, the OTP generating module 230 may set a key value and a parameter value when generating the OTP value. The key value may serve as a basis for the generating of the OTP value, and the seed value may be set as the key value. In addition, the OTP generating module 230 may process the seed value and the biometric ID in a specified algorithm and may set a value obtained through the processing of the algorithm as the key value. The parameter value may be used for various OTP values when the OPT value is generated. The time information of the electronic device may be set as the parameter value. The OTP generating module 230 may perform the operation for the biometric ID and the time information and may set a value obtained through the operation as the parameter value.

According to an embodiment, the parameter value may be set based on location information of the electronic device. For example, if a user uses a security service by using an electronic device installed in a specific location, or uses the security service at a specific place, the OTP generating module 230 may set the parameter value based on the relevant location information (e.g., a GPS value or a place ID). In this case, if the location information does not include preset location information, the OTP generating module 230 may not generate the OTP value. In addition, even if the OTP generating module 230 generates the OTP value, the electronic device may control a relevant module such that only a portion of the security service may be provided or the security service may be restrictively used. In detail, the electronic device may restrict a transfer limit or a transfer manner when providing financial services.

According to another embodiment, the OTP generating module 230 may not generate the OTP value in the case where the electronic device is not paired with another electronic device (e.g., a wearable device) which is preset. In addition, even if the OTP generating module 230 generates the OTP value, the electronic device may control a relevant module such that only a portion of the security service may be provided or the security service may be restrictively used.

As described above, according to various embodiments, an electronic device (e.g., the electronic device 101) may include a sensor module (e.g., the sensor module 180) configured to sense a part of a body of a user, a memory (e.g., the memory 130), and a processor (e.g., the processor 120) operatively connected with the sensor module and the memory. The processor may be configured to acquire at least one piece of first bio-information related to the part of the body of the user through the sensor module, create at least one piece of ID information based on the at least one piece of first bio-information, set at least one of at least one key value and at least one parameter value used for generating at least one OTP by using the at least one piece of ID information, generate the at least one OTP by using the at least one key value and the at least one parameter value, and transmit the at least one OTP to at least one external device.

According to various embodiments, the memory may store at least one piece of second bio-information registered while bio-information of the user is registered, and the processor may be configured to compare bio-information of the at least one piece of first-bio information with corresponding bio-information of the at least one piece of second bio-information, and create the at least one piece of ID information if the bio-information is identical to or similar to the corresponding bio-information.

According to various embodiments, the processor may be configured to map the at least one piece of first bio-information to the at least one piece of ID information to store the at least one piece of first bio-information and the at least one piece of ID information in the memory.

According to various embodiments, the processor may be configured to create multiple pieces of ID information based on one of the at least one piece of first bio-information, generate multiple OTPs, which are different from each other, by using each of the multiple pieces of ID information, and transmit each of the multiple OTPs to external devices which are different from each other.

According to various embodiments, the processor may be configured to create the multiple pieces of ID information by varying a type of an algorithm, which is used in creating the at least one piece of ID information, or a number of times that the algorithm is applied.

According to various embodiments, the algorithm may include a hash function.

According to various embodiments, the at least one piece of first bio-information may include multiple pieces of bio-information, and the processor may be configured to create one of the at least one piece of ID information based on the multiple pieces of bio-information.

According to various embodiments, the at least one piece of first bio-information may include at least one of fingerprint information, iris information, face information, heart rate information, voice information, and blood vessel information.

According to various embodiments, the at least one key value may be set based on a seed value which is stored in the memory and is identical to a seed value of the at least one external device.

According to various embodiments, the at least one parameter value may be set to include at least one of time information and location information of the electronic device.

According to various embodiments, an electronic device may include a housing, a display that is exposed through one surface of the housing, a biometric sensor mounted in a portion of the housing, a wireless communication circuit, a processor electrically connected with the display, the biometric sensor, and the wireless communication circuit, and a memory electrically connected with the processor and configured to store bio-information of a user. The memory may store instructions that, when executed, cause the processor to acquire first bio-information of the user by using the biometric sensor, compare the first bio-information with second bio-information which is stored in the memory, select or create first information based on a comparison result, generate a number based on the first information, second information related to the electronic device, and time information, transmit the number to an external server through the wireless communication circuit, and receive a response related to the number from the external server through the wireless communication circuit.

According to various embodiments, the first information may include an ID number.

According to various embodiments, the second information may include at least one of a serial number and a phone number of the electronic device.

According to various embodiments, the bio-information may be stored in a security area.

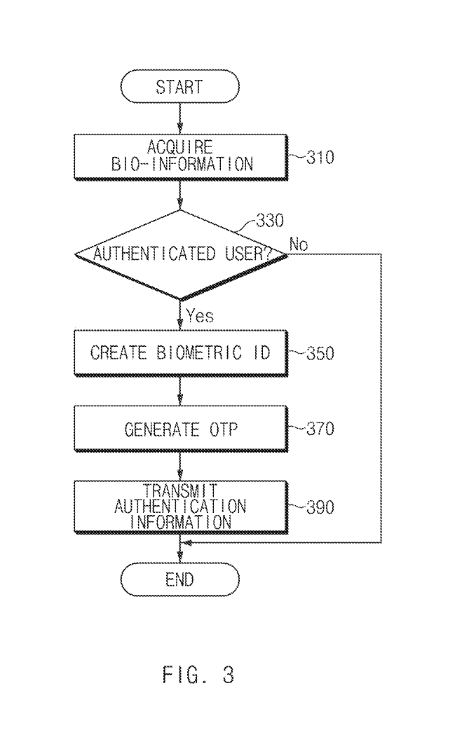

FIG. 3 is a diagram illustrating an operating method of an electronic device associated with a method of authenticating a user according to an embodiment of the present disclosure.

Referring to FIG. 3, according to various embodiments of the present disclosure, the electronic device (e.g., the electronic device 101) may acquire user authentication information (e.g., bio-information) in operation 310. According to an embodiment, the electronic device may acquire the user authentication information from a user through the sensor module (e.g., the sensor module 180). For example, the electronic device may acquire the fingerprint information of the user through the fingerprint recognition sensor. In addition, the electronic device may acquire the iris information of the user through the iris recognition sensor. According to an embodiment, the electronic device may acquire the bio-information of the user from the external device (e.g., the first external electronic device 102, the second external electronic device 104, or the server 106) through a communication interface (e.g., the communication interface 170.)

According to various embodiments of the present disclosure, the electronic device may determine, by using the acquired user authentication information (e.g., bio-information), whether the user is an authenticated user in operation 330. According to an embodiment, the electronic device may compare the acquired bio-information with registered bio-information and may determine the user as the authenticated user if the acquired bio-information is identical to or similar to the registered bio-information. In this case, the registered bio-information may be the bio-information of the user, which is previously stored in a memory (e.g., the memory 130) in the procedure of registering the bio-information of the user.

According to various embodiments, if the user is not the authenticated user, the electronic device may not perform operation 350 to operation 390. For example, if the user is not the authenticated user, the electronic device may perform a transmission failure process such that the security information (e.g., user information or financial transaction information) is prevented from being transmitted to the external device (e.g., the first external electronic device 102, the second external electronic device 104, or the server 106).

According to various embodiments, if the user is the authenticated user, the electronic device may create a biometric ID corresponding to the acquired bio-information in operation 350. In addition, the electronic device may acquire the biometric ID corresponding to the acquired bio-information from the memory. In this case, the electronic device may recognize a biometric ID, which is mapped to the registered bio-information and previously stored in the memory, and may acquire the biometric ID corresponding to the acquired bio-information from the memory.

According to various embodiments of the present disclosure, in operation 370, the electronic device may generate an OTP. According to an embodiment, the electronic device may set at least one of the key value or the parameter value used in generating an OPT value by using the biometric ID. For example, the electronic device may process the biometric ID or the seed value, which is set as the same value as that of the OTP authentication server, in a specified algorithm and may set a result value obtained from the process of the algorithm as the key value. Alternatively, the electronic device may perform the operation for the biometric ID and the time information of the electronic device and may set a value obtained through the operation as the parameter value.

According to various embodiments of the present disclosure, in operation 390, the electronic device may transmit authentication information necessary for user authentication to the authentication server (e.g., the server 106). According to an embodiment, the electronic device may transmit at least one of the biometric ID used for the generation of the OTP or user signature information to the service providing server or the OTP authentication server together with the generated OTP value.

As described above, according to various embodiments, a method of authenticating a user by an electronic device, the method may include acquiring at least one piece of first bio-information related to a part of a body of the user through a sensor module, creating at least one piece of ID information based on the at least one piece of the first bio-information, setting at least one of at least one key value and at least one parameter value used for generating at least one OTP by using the at least one piece of ID information, generating the at least one OTP by using the at least one key value and the at least one parameter value, and transmitting the at least one OTP to at least one external device.

According to various embodiments, the creating of the at least one piece of ID information may include creating multiple pieces of ID information based on one of the at least one piece of first bio-information, the generating of the at least one OPT may include generating OTPs which are mutually different by using each of the multiple pieces of ID information, and the transmitting of the at least one OTP to the at least one external device may include transmitting each of the OTPs to external devices which are different from each other.

According to various embodiments, the creating of the multiple pieces of ID information may include variously setting a type of an algorithm used in creating the at least one piece of ID information or a number of times that the algorithm is applied.

According to various embodiments, the acquiring of the at least one piece of first bio-information may include acquiring multiple pieces of bio-information, and the creating of the at least one piece of ID information may include creating one of the at least one piece of ID information based on the multiple pieces of bio-information.

According to various embodiments, the setting of the at least one of the at least one key value and the at least one parameter value may include setting the at least one key value based on a seed value which is stored in a memory and is identical to a seed value of the at least one external device.

According to various embodiments, the setting of the at least one of the at least one key value and the at least one parameter value may include setting the at least one parameter value to include at least one of time information and location information of the electronic device.

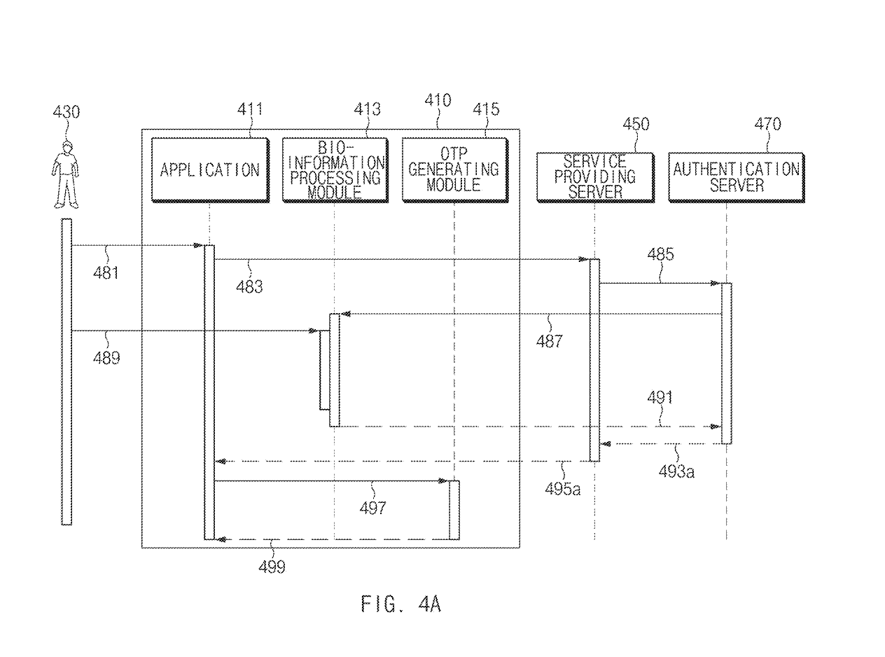

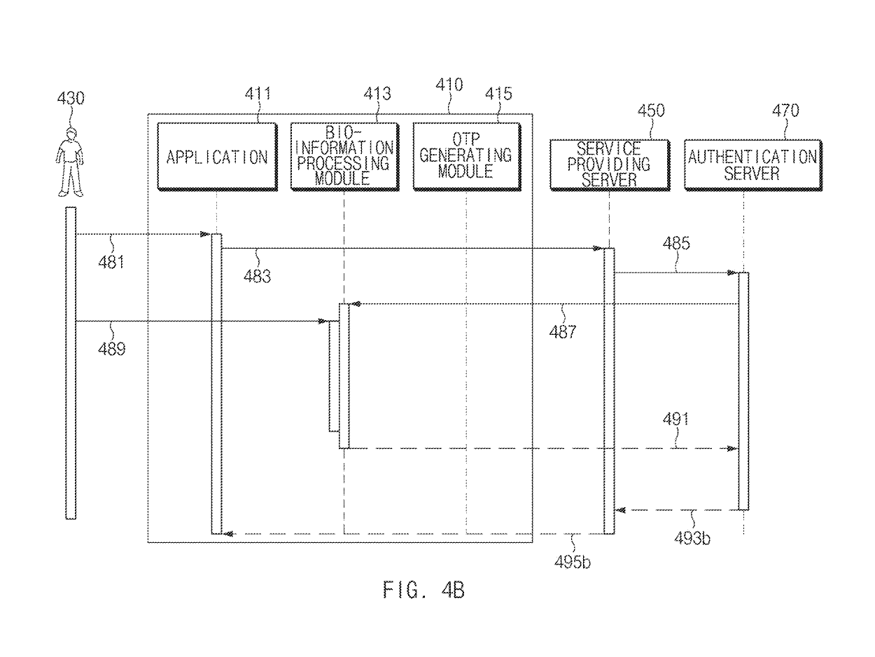

FIG. 4A is a view illustrating setting an OTP according to an embodiment of the present disclosure.

FIG. 4B is a view illustrating another setting of an OTP according to an embodiment of the present disclosure.

Referring to FIGS. 4A and 4B, in operation 481, a user 430 may execute an application 411 installed in an electronic device 410 to set an OTP. The application 411 is a series of programs (or instructions) for executing a specific function. When the application 411 is executed by a processor (e.g., the processor 120), as the instructions are loaded into a memory (e.g., the memory 130), the instructions may be executed along a defined routine. The application 411 may be installed in the electronic device in various manners. For example, the application 411 may include a preloaded application or a third party application which is downloadable from the external electronic device (e.g., the first external electronic device 102, the second external electronic device 104, or the server 106). The application 411 may include an application (e.g., a financial transaction application) for providing a service (e.g., a financial transaction service) requiring high-level security.

According to various embodiments of the present disclosure, in operation 483, the application 411 may request a service providing server 450 to provision the setting of the OTP. In this case, in operation 485, the service providing server 450 may notify an authentication server 470 (e.g., OTP authentication server) of the fact that the user 430 attempts to execute the OTP provisioning. The authentication server 470 may request a bio-information processing module 413 to provide the authentication information of the user 430 in operation 487.

According to various embodiments of the present disclosure, if receiving the request for the authentication information of the user 430 from the authentication server 470, the bio-information processing module 413 may transmit the request to the processor and the processor may control a relevant module to provide an interface for the authentication of the user 430. For example, the processor may output a relevant screen onto a display (e.g., the display 160) such that the user 430 inputs the bio-information into the screen. For example, the processor may control the display to output a screen including a user interface (e.g., a text or an image) for guiding the user such that the sensing area of the sensor module (e.g., the sensor module 180) recognizes the part (e.g., the finger (fingerprint) or the eye (iris)) of the body of the user. In addition, the processor may output, through a voice output device included in an I/O interface (e.g., the I/O interface 150), voice for guiding the user such that the sensing area of the sensor module recognizes the part (e.g., the finger (fingerprint) or the eye (iris)) of the body of the user.

According to various embodiments of the present disclosure, in operation 489, if the user 430 allows the sensing area of the sensor module to recognize the part (e.g., the finger (fingerprint) or eye (iris) of the user, the bio-information processing module 413 may acquire the bio-information of the user. In addition, the bio-information processing module 413 may analyze the acquired bio-information and may determine whether the user 430 is an authenticated user. If the user 430 is determined as being the authenticated user, the bio-information processing module 413 may create a biometric ID corresponding to the acquired bio-information. For example, the bio-information processing module 413 may produce, as the biometric ID, a hash value which is produced as a numeric-string code corresponding to the bio-information is used as an input value of a hash function.

According to various embodiments of the present disclosure, in operation 491, the bio-information processing module 413 may transmit the authentication information of the user 430 to the authentication server 470. According to an embodiment, the bio-information processing module 413 may transmit, to the authentication server 470, at least one of the created biometric ID, certificate information, which is crated at least one of ID information of the electronic device 410 or the information (e.g., user personal information) on the user 430, or user signature information.

According to various embodiments of the present disclosure, the authentication server 470 may create a seed value based on the authentication information, may map the authentication information to the seed value, and may store the authentication information and the seed value. In operation 493a, the authentication server 470 may transmit the seed value to the service providing server 450. The service providing server 450 may or may not store the seed value. In operation 495a, the service providing server 450 may transmit the seed value to the application 411.

According to various embodiments of the present disclosure, in operation 497, the application 411 may transmit the seed value to an OTP generating module 415 and the OTP generating module 415 may store the seed value into the memory (e.g., the memory (130)). In addition, as in operation 499, the OTP generating module 415 may notify the application 411 of the fact that the seed value is stored. Thereafter, the application 411 may notify the processor of the fact that the seed value is stored. The processor may form a screen for notifying that the setting of the OTP is completed and may output the screen onto the display. Alternatively, the processor may output voice for notifying that the setting of the OTP is completed through the voice output device.

According to various embodiments, after the seed value is set (stored) one time, when the user 430 additionally registers another bio-information, the operations as illustrated in FIG. 4B may be performed. According to an embodiment, in operation 491, the bio-information processing module 413 may transmit, to the authentication server 470, at least one of a biometric ID corresponding to the other bio-information, the certificate information, or the user signature information. In this case, the authentication server 470 may determine whether the seed value related to the user 430 is stored. If the seed value related to the user 430 is stored, the authentication server 470 may map the biometric ID corresponding to the other bio-information to the previously stored seed value and may store biometric ID and the previously stored seed value based on the mapping result. In addition, in operation 493b, the authentication server 470 may notify the service providing server 450 of that the biometric ID corresponding to the other bio-information is registered. In operation 495b, the service providing server 450 may transmit the notification to the application 411 Thereafter, the application 411 may notify the processor of the fact that the biometric ID corresponding to the another bio-information is registered. The processor may form a screen for notifying that the biometric ID corresponding to the other bio-information is registered and may output the screen onto the display. Alternatively, the processor may output voice for notifying that the biometric ID corresponding to the other bio-information is registered through the voice output device.

According to various embodiments of the present disclosure, in FIG. 4B, although the application 411, the bio-information processing module 413, and the OTP generating module 415 have been described in that they perform the above operations, the description is provided only for the illustrative purpose. Actually, as the instructions of the application 411, the bio-information processing module 413, and the OTP generating module 415 are executed by the processor, the above operations may be performed. Even the following description will be made for the illustrative purpose in that the application 411, the bio-information processing module 413, and the OTP generating module 415 perform the operations.

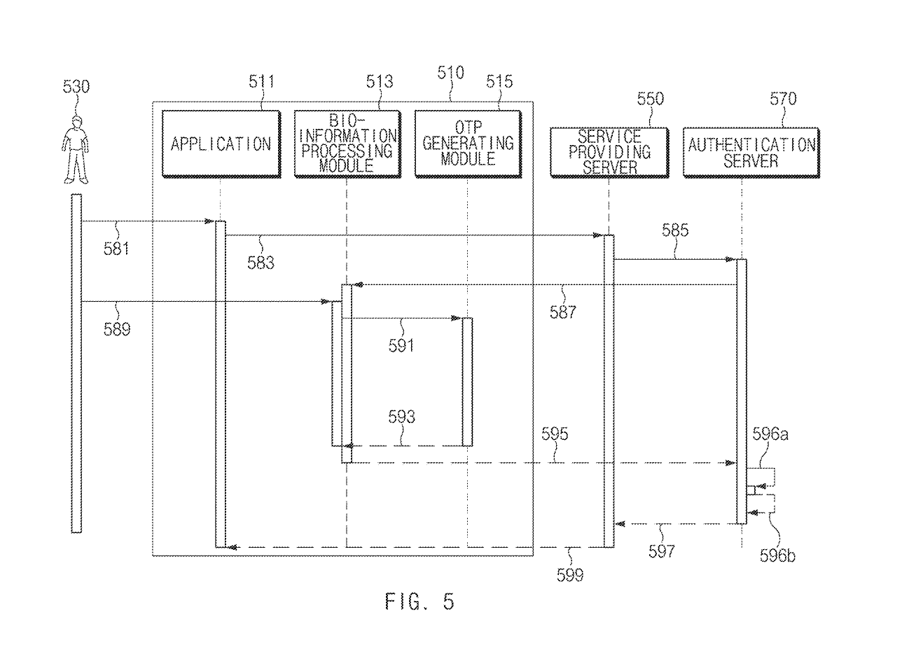

FIG. 5 is a view illustrating a method of authenticating a user by using an OTP according to an embodiment of the present disclosure.

Referring to FIG. 5, according to various embodiments of the present disclosure, in operation 581, a user 530 may execute an application 511 installed in an electronic device 510 to use a high-level security service. For example, the user 530 may execute the application 511 for financial transaction.

According to various embodiments of the present disclosure, in operation 583, the application 511 may request a service providing server 550 to allow the use of the high-level security service. In detail, the application 511 may request the service providing server 550 to provide the financial transaction. In this case, in operation 585, the service providing server 550 may request an authentication server 570 to authenticate the user 530. In operation 587, the authentication server 570 may request a bio-information processing module 513 to transmit the authentication information of the user 530.

According to various embodiments of the present disclosure, if receiving the request for the authentication information of the user 530 from the authentication server 570, the bio-information processing module 513 may transmit the request to the processor and the processor may control a relevant module to provide an interface for the authentication of the user 530. For example, the processor may output a relevant screen onto a display (e.g., the display 160) such that the user 530 inputs the bio-information into the screen. For example, the processor may control the display to output a screen including a user interface (e.g., a text or an image) for guiding the user such that the sensing area of the sensor module (e.g., the sensor module 180) recognizes a part (e.g., a finger (fingerprint) or eye (iris)) of the body of the user. In addition, the processor may output, through a voice output device included in an I/O interface (e.g., the I/O interface 150), voice for guiding the user such that the sensing area of the sensor module recognizes the part (e.g., a finger (fingerprint) or eye (iris)) of the body of the user.

According to various embodiments of the present disclosure, in operation 589, if the user 530 allows the sensing area of the sensor module to recognize the part (e.g., the finger (fingerprint) or eye (iris)) of the body of the user, the bio-information processing module 513 may acquire the bio-information of the user. In addition, the bio-information processing module 513 may determine, by analyzing the acquired bio-information, whether the user 530 is an authenticated user. If the user 530 is determined as being the authenticated user, the bio-information processing module 513 may acquire a biometric ID corresponding to the acquired bio-information from a memory (e.g., a memory 130). For example, the bio-information authenticating module 513 may acquire the biometric ID, which is mapped to the acquired bio-information, from the memory.

According to various embodiments of the present disclosure, in operation 591, the bio-information processing module 513 may transmit the biometric ID to an OTP generating module 515. The OTP generating module 515 may generate an OTP value based on the biometric ID. According to an embodiment, the OTP generating module 515 may set at least one of a key value and a parameter value used for generating the OTP value by using the biometric ID. For example, the OTP generating module 515 may process the seed value and the biometric ID in a specified algorithm and may set a value obtained through the processing of the algorithm as the key value. Alternatively, the OTP generating module 515 may perform the operation for the biometric ID and the time information (e.g., current time) of the electronic device 510 and may set the value obtained through the operation as the parameter value.

According to various embodiments, in operation 593, the OTP generating module 515 may transmit the generated OTP value to the bio-information processing module 513. In operation 595, the bio-information processing module 513 may transmit the authentication information of the user 530 to the authentication server 570. According to an embodiment, the bio-information processing module 513 may transmit, to the authentication server 570, at least one of the OTP value, the biometric ID used in generating the OTP value, and the user signature information

According to an embodiment of the present disclosure, the authentication server 570 may authenticate the user 530 based on the authentication information. For example, in operation 596a, the authentication server 570 may verify the user signature information to determine whether the user 530 is an authenticated user. In addition, in operation 596b, the authentication server 570 may verify the OTP value to determine whether the OTP value is generated by using the key value and the parameter value corresponding to the authenticated user 530. In detail, the authentication server 570 may determine whether the OPT value is generated based on the biometric ID.

In operation 597, according to various embodiments of the present disclosure, the authentication server 570 may transmit the authentication result for the user 530 to the service providing server 550 and the service providing server 550 may process a service depending on the authentication result. For example, the service providing server 550 may process the requested financial transaction if the authentication for the user 530 is succeeded. Alternatively, the service providing server 550 may not process the requested financial transaction if the authentication of the user 530 is failed.

According to various embodiments of the present disclosure, in operation 599, the service providing server 550 may transmit the result of the process for the financial transaction service to the application 511. Thereafter, the application 511 may notify the processor of the process result for the financial transaction service. The processor may form a screen for notifying the process result for the financial transaction service and may output the screen onto the display. Alternatively, the processor may output voice for notifying the process result for the financial transaction service through the voice output device.

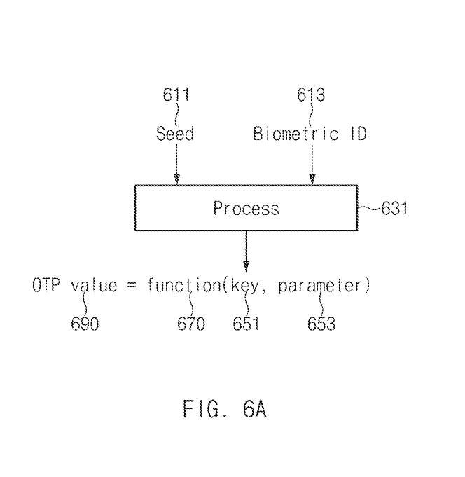

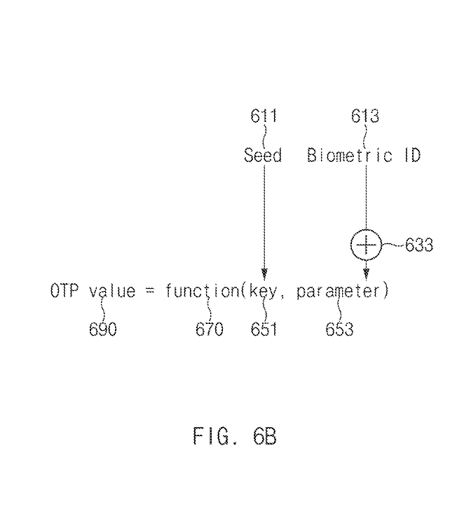

FIG. 6A is a view illustrating generating an OTP value according to an embodiment of the present disclosure.

FIG. 6B is a view illustrating another generating of an OTP value according to an embodiment of the present disclosure.

Referring to FIGS. 6A and 6B, as the electronic device (e.g., the electronic device 101) generates and provides an OTP value 690, when a service requiring security is used, the reliability of user authentication may be enhanced. According to an embodiment, when the electronic device generates the OTP value 690 in an OTP generation algorithm 670, the electronic device may set at least one of a key value 651 and a parameter value 653 by using ID information (biometric ID) 613 of bio-information. The OTP generation algorithm 670 may include, for example, an HMAC-SHA1 algorithm.

As illustrated in FIG. 6A, the electronic device may process a seed value 611 and the biometric ID 613 in a specific algorithm 631 and may set the key value 651 to a process result value obtained through the processing of the algorithm. In addition, as illustrated in FIG. 6B, the electronic device may perform the operation for the biometric ID 613 and another parameter value 653 (e.g., time information or location information of the electronic device) (633) and may set the parameter value 653 to a value obtained through the operation process.

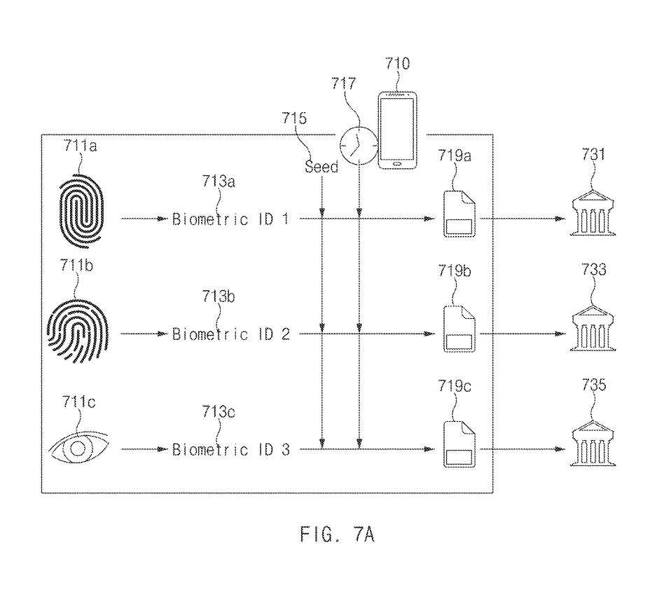

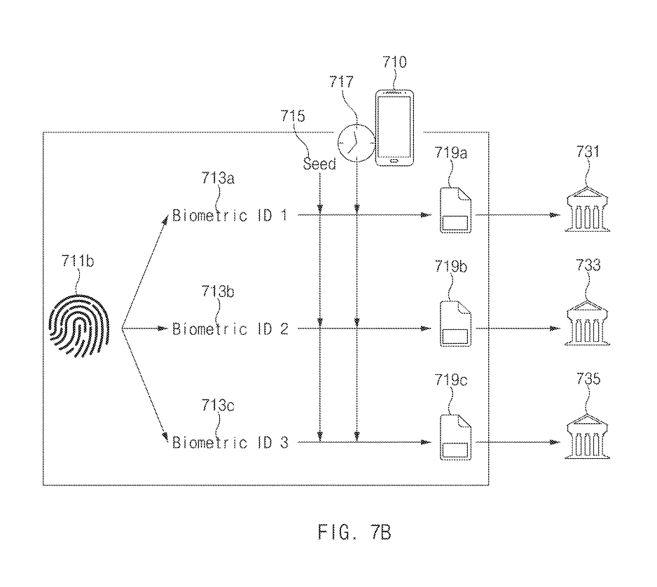

FIG. 7A is a view illustrating generating an OTP value corresponding to each of multiple pieces of bio-information according to an embodiment of the present disclosure.

FIG. 7B is a view illustrating generating OTP values using one piece of bio-information according to an embodiment of the present disclosure.

Referring to FIGS. 7A and 7B, according to various embodiments of the present disclosure, an electronic device 710 may generate multiple OPT values and may request a service providing server to perform user authentication and provide a service by using each of the multiple OTP values that are generated. According to an embodiment, the electronic device 710 may generate an OTP value corresponding to each of multiple pieces of bio-information, which is different from each other, as illustrated in FIG. 7A. For example, the electronic device 710 may create a first biometric ID 713a, a second biometric ID 713b, and a third biometric ID 713c corresponding to first bio-information 711a (e.g., fingerprint information of a thumb), second bio-information 711b (e.g., fingerprint information of an index finger), and third bio-information 711c (e.g., iris information). In addition, the electronic device 710 may generate a first OTP value 719a, a second OTP value 719b, and a third OTP value 719c by using the first biometric ID 713a, the second biometric ID 713b, and the third biometric ID 713c, respectively, while using the seed value 715 or the time information 717 of the electronic device 710 in common. The first OTP value 719a, the second OTP value 719b, and the third OTP value 719c, which are generate as described above, may be used when a first service providing server 731 (e.g., a first bank server), a second service providing server 733 (e.g., a second bank server), and a third service providing server 735 (e.g., a third bank server) are requested to perform user authentication and to provide a service.

According to an embodiment, as illustrated in FIG. 7B, multiple pieces of OTP values may be generated with respect to one bio information. In detail, the electronic device 710 may create the first biometric ID 713a, the second biometric ID 713b, and the third biometric ID 713c corresponding to the second bio-information 711b. According to an embodiment, the electronic device 710 may create multiple pieces of bio-information, which is different from each other, by varying the number of times that an algorithm (e.g., a hash function) used for creation of a biometric ID corresponding to the bio-information is applied. In detail, the electronic device 710 may create biometric IDs, which are different from each other, through a scheme of employing a hash value, which is produced as a numeric-string code corresponding to the bio-information is used as an input value of a hash function, as an input value of the hash function. For example, the electronic device 710 may produce, as the first biometric ID 713a, a first hash value produced by employing a numeric doe string corresponding to the second bio-information 711b as the input value of the hash function. For example, the electronic device 710 may produce, as the second biometric ID 713b, a second hash value produced by employing the first hash value as the input value of the hash function. In addition, the electronic device 710 may produce, as the third biometric ID 713c, a third hash value produced by employing the second hash value as the input value of the hash function.

According to various embodiments, the electronic device 710 may create various biometric IDs according to types of applications. For example, the electronic device 710 may create various biometric IDs according to the types of the applications even if the same bio-information is provided. For example, the electronic device 710 may create the first biometric ID 719a in the case of a first application accessible to the first service providing server 731, may create the second biometric ID 719b in the case of a second application accessible to the second service providing server 733, and may create the third biometric ID 719c in the case of a third application accessible to the third service providing server 735.

According to an embodiment, the electronic device 710 may store information, which is obtained by mapping the type of the application to the biometric ID corresponding to the type of the application, in a memory (e.g., the memory 130)). For example, the electronic device 710 may store, in the memory, a lookup table in which ID information of the application (e.g., an application ID) is mapped to biometric ID.

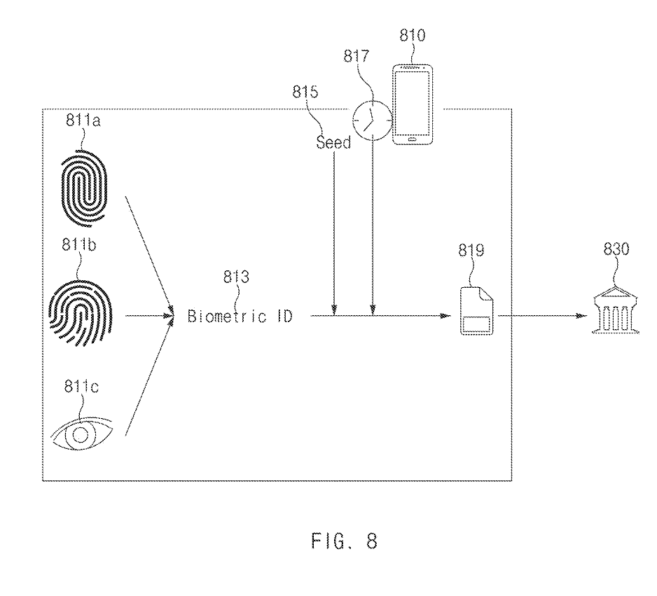

FIG. 8 is a view illustrating generating an OTP value by using multiple pieces of bio-information according to an embodiment of the present disclosure.

Referring to FIG. 8, according to various embodiments of the present disclosure, an electronic device 810 may generate an OTP value by using various pieces of bio-information and may request a service providing server to perform user authentication and to provide a service by using the generated OTP value. According to an embodiment, the electronic device 810 may generate one OTP value corresponding to multiple pieces of bio-information, which are different from each other. For example, the electronic device 810 may create one biometric ID 813 corresponding to first bio-information 811a (e.g., fingerprint information of a thumb), second bio-information 811b (e.g., fingerprint information of an index finger), and third bio-information 811c (e.g., iris information). In addition, the electronic device 810 may generate an OTP value 819 by using the biometric ID 813 of the bio-information together with a seed value 815 and time information 817 of the electronic device 810. The OTP value 819, which is generated as described above, may be used when the service providing server 830 (e.g., a bank server) is requested to perform the user authentication and to provide a service. Accordingly, a user of the electronic device 810 may be provided with a desired service regardless of types of bio-information inputted by the user.

According to various embodiments, the electronic device 810 may group and manage various pieces of bio-information of the user while mapping the grouped bio-information to one biometric ID. In addition, the electronic device 810 may the first bio-information 811a, the second bio-information 811b, and the third bio-information 811c into a first group, and the bio-information included in the first group may be mapped to one biometric ID 819. According to an embodiment, the electronic device 810 may divide multiple pieces of bio-information of the user into multiple groups, and the bio-information included in each group may be mapped to one respective biometric ID among biometric IDs which are different from each other. In detail, the electronic device 810 may set the first bio-information 811a and the second bio-information 811b into the first group, and the third bio-information 811c may be set into a second group. In addition, the electronic device 810 may map the bio-information included in the first group to the first biometric ID (e.g., the first biometric ID 719a) and may map the bio-information included in the second group to the second bio-information (e.g., the second biometric ID 719b).

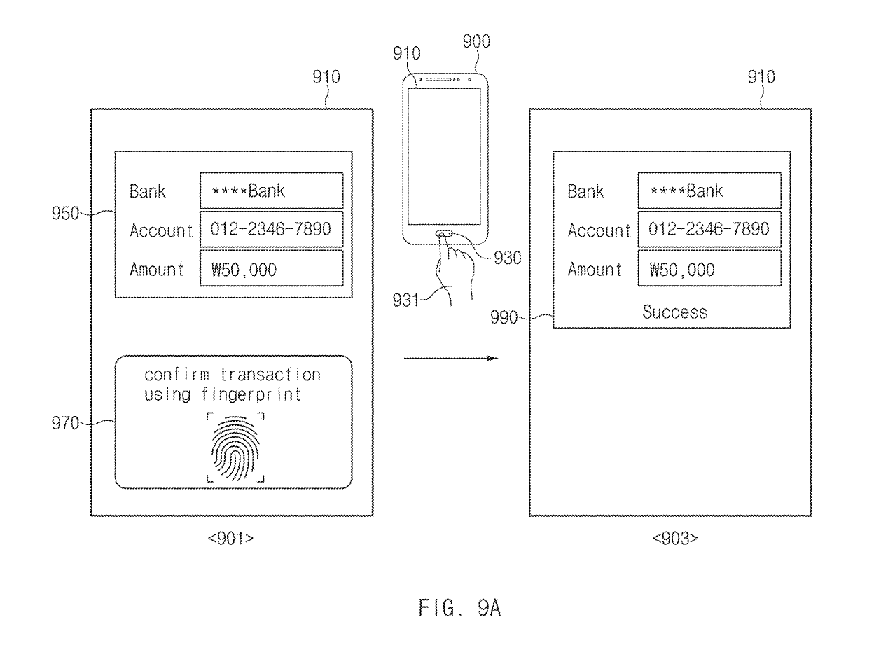

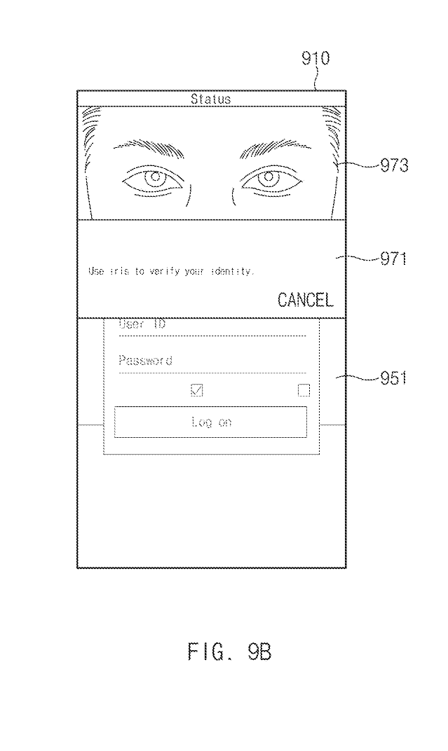

FIG. 9A is a view illustrating a screen to describe a method of authenticating a user through fingerprint recognition according to an embodiment of the present disclosure.

FIG. 9B is a view illustrating a screen to describe the method of authenticating the user through iris recognition according to an embodiment of the present disclosure.

Referring to FIGS. 9A and 9B, according to various embodiments of the present disclosure, an electronic device 900 may perform a procedure of authenticating a user when a service requiring security is provided. According to an embodiment, the electronic device 900 may generate an OTP value by using a biometric ID created based on bio-information of a user, and may request an authentication server to perform user authentication by using the generated OTP value.

According to an embodiment, the electronic device 900 may support the user such that the user authentication is performed only if the user performs only a motion of recognizing the body of the user without separately inputting the generated OTP value, thereby enhancing the convenience of the user in the user authentication. For example, as illustrated in first state (901) of FIG. 9A or in FIG. 9B, the electronic device 900 may output the details 950 (e.g., financial transaction information) of the service onto a display 910 while outputting a display object 970 or 971 for allowing the user to perform the motion of recognizing the body of the user. For example, the details 950 of the service may include, for example, bank information, account information, or transfer amount information. The display object 970 or 971 may include, for example, a user interface (e.g., a text or an image) for providing a guide such that a part 931 (e.g., a finger or an eye) of the body of the user is recognized at the sensing area of a sensor module 930 (e.g., the finger recognition sensor or the iris recognition sensor). According to an embodiment, the electronic device 900 may output a screen 951 for inputting a password, a pin-code, or a pattern set by a user. If the user inputs the password, the pin-code, or the pattern, the electronic device 900 may output the display object 970 or 971 onto the display 910 to guide the user to perform the motion for recognizing the body of the user. In this case, the electronic device 900 may deactivate (e.g., dim-process) the screen 951. However, the present disclosure is not limited thereto. After the body of the user is recognized, the screen 951 for inputting the password, the pin-code, or the pattern set by the user may be displayed.

According to an embodiment, the electronic device 900 may acquire bio-information on the part 931 of the body of the user if the user allows the sensing area of the sensor module 930 to recognize the part 931 of the body. According to an embodiment, the electronic device 900 may display a screen 973 for displaying the part 931 of the body of the user recognized by the sensing area of the sensor module 930 on the display 910. The electronic device 900 may analyze the acquired bio-information and may determine whether the bio-information is bio-information of an authenticated user. In addition, if the bio-information is the bio-information of the authenticated user, the electronic device 900 may acquire a biometric ID corresponding to the bio-information from a memory (e.g., the memory 130) and may generate an OTP value based on the biometric ID. In this case, the electronic device 900 may not display the generated OTP value on the display 910.

According to an embodiment, the electronic device 900 may transmit the OTP value to the authentication server to request for the user authentication without requiring the input of the generated OTP value by the user. In detail, the electronic device 900 may transmit the OTP value to the authentication server in background state even if the user does not input the generated OTP value. The authentication server may verify the OTP value to determine whether the OTP value is generated based on the key value and the parameter value corresponding to the authenticated user. In detail, the authentication server may determine whether the OPT value is generated based on the biometric ID. If the OTP value is successfully verified, the authentication server may notify the service providing server (e.g., a bank server) of the fact that the user authentication is succeeded and the service providing server may process the service (e.g., the financial transaction service). If the service is completely processed, the service providing server may transmit, to the electronic device 900, the process result for the service. As illustrated in second state (903), the electronic device 900 may display the display object 990 corresponding to the process result for the service on the display 910.

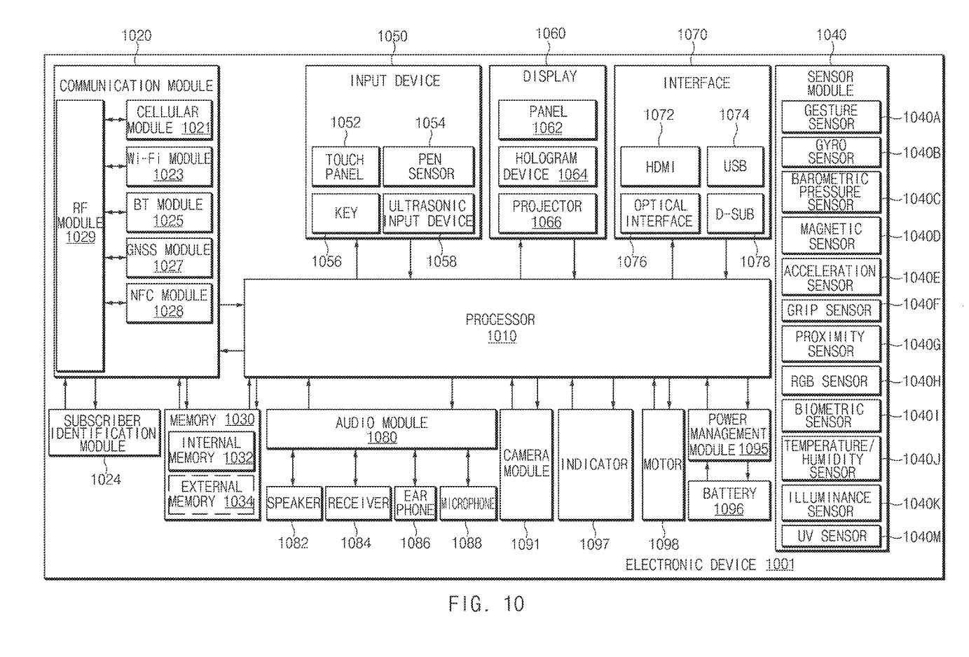

FIG. 10 is a block diagram illustrating an electronic device according to an embodiment of the present disclosure.

Referring to FIG. 10, an electronic device 1001 may include, for example, a part or the entirety of the electronic device 101 illustrated in FIG. 1. The electronic device 1001 may include at least one processor (e.g., AP) 1010, a communication module 1020, a subscriber identification module (SIM) 1024, a memory 1030, a sensor module 1040, an input device 1050, a display 1060, an interface 1070, an audio module 1080, a camera module 1091, a power management module 1095, a battery 1096, an indicator 1097, and a motor 1098.

The processor 1010 may run an OS or an application program so as to control a plurality of hardware or software elements connected to the processor 1010, and may process various data and perform operations. The processor 1010 may be implemented with, for example, a system on chip (SoC). According to an embodiment of the present disclosure, the processor 1010 may further include a graphic processing unit (GPU) and/or an image signal processor (ISP). The processor 1010 may include at least a portion (e.g., a cellular module 1021) of the elements illustrated in FIG. 10. The processor 1010 may load, on a volatile memory, an instruction or data received from at least one of other elements (e.g., a nonvolatile memory) to process the instruction or data, and may store various data in a nonvolatile memory.

The communication module 1020 may have a configuration that is the same as or similar to that of the communication interface 170 of FIG. 1. The communication module 1020 may include, for example, the cellular module 1021, a Wi-Fi module 1023, a BT module 1025, a GNSS module 1027 (e.g., a GPS module, a GLONASS module, a BeiDou module, or a Galileo module), a NFC module 1028, and a radio frequency (RF) module 1029.

The cellular module 1021 may provide, for example, a voice call service, a video call service, a text message service, or an Internet service through a communication network. The cellular module 1021 may identify and authenticate the electronic device 1001 in the communication network using the SIM 1024 (e.g., a SIM card). The cellular module 1021 may perform at least a part of functions that may be provided by the processor 1010. The cellular module 1021 may include a CP.

Each of the Wi-Fi module 1023, the BT module 1025, the GNSS module 1027 and the NFC module 1028 may include, for example, a processor for processing data transmitted/received through the modules. According to some various embodiments of the present disclosure, at least a part (e.g., two or more) of the cellular module 1021, the Wi-Fi module 1023, the BT module 1025, the GNSS module 1027, and the NFC module 1028 may be included in a single integrated chip (IC) or IC package.

The RF module 1029 may transmit/receive, for example, communication signals (e.g., RF signals). The RF module 1029 may include, for example, a transceiver, a power amp module (PAM), a frequency filter, a low noise amplifier (LNA), an antenna, and the like. According to another embodiment of the present disclosure, at least one of the cellular module 1021, the Wi-Fi module 1023, the BT module 1025, the GNSS module 1027, or the NFC module 1028 may transmit/receive RF signals through a separate RF module.

The SIM 1024 may include, for example, an embedded SIM and/or a card containing the subscriber identity module, and may include unique ID information (e.g., an integrated circuit card identifier (ICCID)) or subscriber information (e.g., international mobile subscriber identity (IMSI)).

The memory 1030 (e.g., the memory 130) may include, for example, an internal memory 1032 or an external memory 1034. The internal memory 1032 may include at least one of a volatile memory (e.g., a dynamic random access memory (DRAM), a static RAM (SRAM), a synchronous dynamic RAM (SDRAM), or the like), a nonvolatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory, a NOR flash memory, and the like)), a hard drive, or a solid state drive (SSD).

The external memory 1034 may include a flash drive such as a compact flash (CF), a secure digital (SD), a micro-SD, a mini-SD, an extreme digital (xD), a multi-media-card (MMC), a memory stick, or the like. The external memory 1034 may be operatively and/or physically connected to the electronic device 1001 through various interfaces.

The sensor module 1040 may, for example, measure physical quantity or detect an operation state of the electronic device 1001 so as to convert measured or detected information into an electrical signal. The sensor module 1040 may include, for example, at least one of a gesture sensor 1040A, a gyro sensor 1040B, a barometric pressure sensor 1040C, a magnetic sensor 1040D, an acceleration sensor 1040E, a grip sensor 1040F, a proximity sensor 1040G, a color sensor 1040H (e.g., a red/green/blue (RGB) sensor), a biometric sensor 1040I, a temperature/humidity sensor 1040J, an illumination sensor 1040K, or an ultraviolet (UV) sensor 1040M. Additionally or alternatively, the sensor module 1040 may include, for example, an olfactory sensor (E-nose sensor), an electromyography (EMG) sensor, an electroencephalogram (EEG) sensor, an electrocardiogram (ECG) sensor, an infrared (IR) sensor, an iris recognition sensor, and/or a fingerprint sensor. The sensor module 1040 may further include a control circuit for controlling at least one sensor included therein. In some various embodiments of the present disclosure, the electronic device 1001 may further include a processor configured to control the sensor module 1040 as a part of the processor 1010 or separately, so that the sensor module 1040 is controlled while the processor 1010 is in a sleep state.

The input device 1050 may include, for example, a touch panel 1052, a (digital) pen sensor 1054, a key 1056, or an ultrasonic input device 1058. The touch panel 1052 may employ at least one of capacitive, resistive, infrared, and UV sensing methods. The touch panel 1052 may further include a control circuit. The touch panel 1052 may further include a tactile layer so as to provide a haptic feedback to a user.

The (digital) pen sensor 1054 may include, for example, a sheet for recognition which is a part of a touch panel or is separate. The key 1056 may include, for example, a physical button, an optical button, or a keypad. The ultrasonic input device 1058 may sense ultrasonic waves generated by an input tool through a microphone 1088 so as to identify data corresponding to the ultrasonic waves sensed.

The display 1060 (e.g., the display 160) may include a panel 1062, a hologram device 1064, or a projector 1066. The panel 1062 may have a configuration that is the same as or similar to that of the display 160 of FIG. 1. The panel 1062 may be, for example, flexible, transparent, or wearable. The panel 1062 and the touch panel 1052 may be integrated into a single module. The hologram device 1064 may display a stereoscopic image in a space using a light interference phenomenon. The projector 1066 may project light onto a screen so as to display an image. The screen may be disposed in the inside or the outside of the electronic device 1001. According to an embodiment of the present disclosure, the display 1060 may further include a control circuit for controlling the panel 1062, the hologram device 1064, or the projector 1066.

The interface 1070 may include, for example, an HDMI 1072, a USB 1074, an optical interface 1076, or a D-subminiature (D-sub) 1078. The interface 1070, for example, may be included in the communication interface 170 illustrated in FIG. 1. Additionally or alternatively, the interface 1070 may include, for example, a mobile high-definition link (MHL) interface, an SD card/MMC interface, or an infrared data association (IrDA) interface.

The audio module 1080 may convert, for example, a sound into an electrical signal or vice versa. At least a portion of elements of the audio module 1080 may be included in the I/O interface 150 illustrated in FIG. 1. The audio module 1080 may process sound information input or output through a speaker 1082, a receiver 1084, an earphone 1086, or the microphone 1088.

The camera module 1091 is, for example, a device for shooting a still image or a video. According to an embodiment of the present disclosure, the camera module 1091 may include at least one image sensor (e.g., a front sensor or a rear sensor), a lens, an ISP, or a flash (e.g., an LED or a xenon lamp).

The power management module 1095 may manage power of the electronic device 1001. According to an embodiment of the present disclosure, the power management module 1095 may include a power management integrated circuit (PMIC), a charger integrated circuit (IC), or a battery or gauge. The PMIC may employ a wired and/or wireless charging method. The wireless charging method may include, for example, a magnetic resonance method, a magnetic induction method, an electromagnetic method, or the like. An additional circuit for wireless charging, such as a coil loop, a resonant circuit, a rectifier, or the like, may be further included. The battery gauge may measure, for example, a remaining capacity of the battery 1096 and a voltage, current or temperature thereof while the battery is charged. The battery 1096 may include, for example, a rechargeable battery and/or a solar battery.

The indicator 1097 may display a specific state of the electronic device 1001 or a part thereof (e.g., the processor 1010), such as a booting state, a message state, a charging state, or the like. The motor 1098 may convert an electrical signal into a mechanical vibration, and may generate a vibration or haptic effect. Although not illustrated, a processing device (e.g., a GPU) for supporting a mobile TV may be included in the electronic device 1001. The processing device for supporting a mobile TV may process media data according to the standards of digital multimedia broadcasting (DMB), digital video broadcasting (DVB), MediaFLO™, or the like.

Each of the elements described herein may be configured with one or more components, and the names of the elements may be changed according to the type of an electronic device. In various embodiments of the present disclosure, an electronic device may include at least one of the elements described herein, and some elements may be omitted or other additional elements may be added. Furthermore, some of the elements of the electronic device may be combined with each other so as to form one entity, so that the functions of the elements may be performed in the same manner as before the combination.

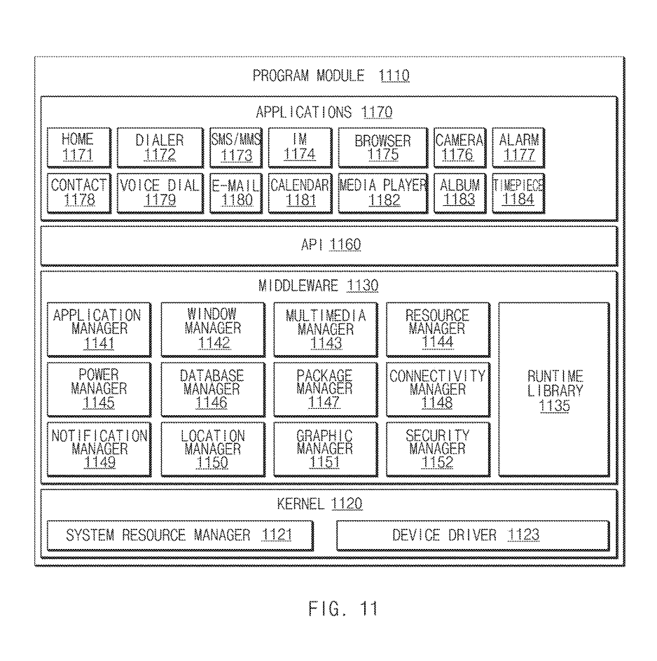

FIG. 11 is a block diagram illustrating a program module according to an embodiment of the present disclosure.

Referring to FIG. 11, a program module 1110 (e.g., the program 140) may include an OS for controlling a resource related to an electronic device (e.g., the electronic device 101) and/or various applications (e.g., the application program 147) running on the OS. The OS may be, for example, Android, iOS, Windows, Symbian, Tizen, and the like.

The program module 1110 may include a kernel 1120, a middleware 1130, an API 1160, and/or an application 1170. At least a part of the program module 1110 may be preloaded on an electronic device or may be downloaded from an external electronic device (e.g., the first external electronic device 102, the second external electronic device 104, or the server 106).

The kernel 1120 (e.g., the kernel 141) may include, for example, a system resource manager 1121 or a device driver 1123. The system resource manager 1121 may perform control, allocation, or retrieval of a system resource. According to an embodiment of the present disclosure, the system resource manager 1121 may include a process management unit, a memory management unit, a file system management unit, or the like. The device driver 1123 may include, for example, a display driver, a camera driver, a BT driver, a shared memory driver, a USB driver, a keypad driver, a Wi-Fi driver, an audio driver, or an inter-process communication (IPC) driver.

The middleware 1130, for example, may provide a function that the applications 1170 require in common, or may provide various functions to the applications 1170 through the API 1160 so that the applications 1170 may efficiently use limited system resources in the electronic device. According to an embodiment of the present disclosure, the middleware 1130 (e.g., the middleware 143) may include at least one of a runtime library 1135, an application manager 1141, a window manager 1142, a multimedia manager 1143, a resource manager 1144, a power manager 1145, a database manager 1146, a package manager 1147, a connectivity manager 1148, a notification manager 1149, a location manager 1150, a graphic manager 1151, and a security manager 1152.

The runtime library 1135 may include, for example, a library module that a complier uses to add a new function through a programming language while the application 1170 is running. The runtime library 1135 may perform a function for I/O management, memory management, or an arithmetic function.

The application manager 1141 may mange, for example, a life cycle of at least one of the applications 1170. The window manager 1142 may manage a GUI resource used in a screen. The multimedia manager 1143 may recognize a format required for playing various media files and may encode or decode a media file using a codec matched to the format. The resource manager 1144 may manage a resource such as a source code, a memory, or a storage space of at least one of the applications 1170.

The power manager 1145, for example, may operate together with a basic input/output system (BIOS) to manage a battery or power and may provide power information required for operating the electronic device. The database manager 1146 may generate, search, or modify a database to be used in at least one of the applications 1170. The package manager 1147 may manage installation or update of an application distributed in a package file format.

The connectivity manger 1148 may manage wireless connection of Wi-Fi, BT, or the like. The notification manager 1149 may display or notify an event such as message arrival, appointments, and proximity alerts in such a manner as not to disturb a user. The location manager 1150 may manage location information of the electronic device. The graphic manager 1151 may manage a graphic effect to be provided to a user or a user interface related thereto. The security manager 1152 may provide various security functions required for system security or user authentication. According to an embodiment of the present disclosure, in the case in which an electronic device (e.g., the electronic device 101) includes a phone function, the middleware 1130 may further include a telephony manager for managing a voice or video call function of the electronic device.

The middleware 1130 may include a middleware module for forming a combination of various functions of the above-mentioned elements. The middleware 1130 may provide a module specialized for each type of an OS to provide differentiated functions. Furthermore, the middleware 1130 may delete a part of existing elements or may add new elements dynamically.

The API 1160 (e.g., the API 145) which is, for example, a set of API programming functions may be provided in different configurations according to an OS. For example, in the case of Android or iOS, one API set may be provided for each platform, and, in the case of Tizen, at least two API sets may be provided for each platform.

The application 1170 (e.g., the application program 147), for example, may include at least one application capable of performing functions such as a home 1171, a dialer 1172, a short message service (SMS)/multimedia messaging service (MMS) 1173, an instant message (IM) 1174, a browser 1175, a camera 1176, an alarm 1177, a contact 1178, a voice dial 1179, an e-mail 1180, a calendar 1181, a media player 1182, an album 1183, a clock 1184, health care (e.g., measure an exercise amount or blood sugar), or environmental information provision (e.g., provide air pressure, humidity, or temperature information).

According to an embodiment of the present disclosure, the application 1170 may include an information exchange application for supporting information exchange between the electronic device (e.g., the electronic device 101) and an external electronic device (e.g., the first external electronic device 102 or the second external electronic device 104). The information exchange application may include, for example, a notification relay application for relaying specific information to the external electronic device or a device management application for managing the external electronic device.

For example, the notification relay application may have a function for relaying, to an external electronic device (e.g., the first external electronic device 102 or the second external electronic device 104), notification information generated in another application (e.g., an SMS/MMS application, an e-mail application, a health care application, an environmental information application, or the like) of the electronic device. Furthermore, the notification relay application may receive notification information from the external electronic device and may provide the received notification information to the user.

The device management application, for example, may manage (e.g., install, delete, or update) at least one function (e.g., turn-on/turn off of the external electronic device itself (or some elements) or the brightness (or resolution) adjustment of a display) of the external electronic device (e.g., the first external electronic device 102 or the second external electronic device 104) communicating with the electronic device, an application running in the external electronic device, or a service (e.g., a call service, a message service, or the like) provided from the external electronic device.

According to an embodiment of the present disclosure, the application 1170 may include a specified application (e.g., a healthcare application of a mobile medical device) according to an attribute of the external electronic device (e.g., the first external electronic device 102 or the second external electronic device 104). The application 1170 may include an application received from an external electronic device (e.g., the first external electronic device 102 or the second external electronic device 104). The application 1170 may include a preloaded application or a third-party application downloadable from a server. The names of the elements of the program module 1110 illustrated may vary with the type of an OS.

According to various embodiments of the present disclosure, at least a part of the program module 1110 may be implemented with software, firmware, hardware, or a combination thereof. At least a part of the program module 1110, for example, may be implemented (e.g., executed) by a processor (e.g., the processor 1010). At least a part of the program module 1110 may include, for example, a module, a program, a routine, sets of instructions, or a process for performing at least one function.

According to various embodiments disclosed in the present disclosure, the OTP is generated based on the user authentication information (e.g., bio-information), thereby enhancing the reliability in authenticating a user by using the OTP.

According to various embodiments disclosed in the present disclosure, in the case that the OTP is generated based on the bio-information, the user authentication may be performed even if only the motion of recognizing a body of the user is performed, thereby providing the convenience of the user when the user authentication is performed.

The term “module” used herein may represent, for example, a unit including one of hardware, software and firmware or a combination thereof. The term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” may include at least one of an application-specific integrated circuit (ASIC) chip, a field-programmable gate array (FPGA), and a programmable-logic device for performing some operations, which are known or will be developed.

At least a part of devices (e.g., modules or functions thereof) or methods (e.g., operations) according to various embodiments of the present disclosure may be implemented as instructions stored in a computer-readable storage medium in the form of a program module. In the case where the instructions are performed by a processor (e.g., the processor 120), the processor may perform functions corresponding to the instructions. The computer-readable storage medium may be, for example, the memory 130.

A computer-readable recording medium may include a hard disk, a floppy disk, a magnetic medium (e.g., a magnetic tape), an optical medium (e.g., compact disc-ROM (CD-ROM), DVD), a magneto-optical medium (e.g., a floptical disk), or a hardware device (e.g., a ROM, a RAM, a flash memory, or the like). The program instructions may include machine language codes generated by compilers and high-level language codes that can be executed by computers using interpreters. The above-mentioned hardware device may be configured to be operated as one or more software modules for performing operations of various embodiments of the present disclosure and vice versa.

A module or a program module according to various embodiments of the present disclosure may include at least one of the above-mentioned elements, or some elements may be omitted or other additional elements may be added. Operations performed by the module, the program module or other elements according to various embodiments of the present disclosure may be performed in a sequential, parallel, iterative or heuristic way. Furthermore, some operations may be performed in another order or may be omitted, or other operations may be added.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a sensor configured to sense a part of a body of a user;
a memory; and
at least one processor operatively connected with the sensor and the memory,
wherein the at least one processor is configured to:
acquire at least one piece of first bio-information related to the part of the body of the user through the sensor,
create at least one piece of identification (ID) information based on the at least one piece of first bio-information,
set at least one of at least one key value or at least one parameter value used for generating at least one one-time password (OTP) by using the at least one piece of ID information,
generate the at least one OTP by using the at least one key value and the at least one parameter value, and
transmit the at least one OTP to at least one external device.

2. The electronic device of claim 1,
wherein the memory is configured to store at least one piece of second bio-information registered while bio-information of the user is registered, and
wherein the at least one processor is further configured to:
compare bio-information of the at least one piece of first-bio information with corresponding bio-information of the at least one piece of second bio-information, and
create the at least one piece of ID information if the bio-information is identical to or similar to the corresponding bio-information.

3. The electronic device of claim 1, wherein the at least one processor is further configured to:
map the at least one piece of first bio-information to the at least one piece of ID information to store the at least one piece of first bio-information and the at least one piece of ID information in the memory.

4. The electronic device of claim 1, wherein the at least one processor is further configured to:
create multiple pieces of ID information based on one of the at least one piece of first bio-information,
generate multiple OTPs, which are different from each other, by using each of the multiple pieces of ID information, and
transmit each of the multiple OTPs to external devices which are different from each other.

5. The electronic device of claim 4, wherein the at least one processor is further configured to:
create the multiple pieces of ID information by varying a type of an algorithm, which is used in creating the at least one piece of ID information, or a number of times that the algorithm is applied.

6. The electronic device of claim 5, wherein the algorithm includes a hash function.

7. The electronic device of claim 1,
wherein the at least one piece of first bio-information includes multiple pieces of bio-information, and
wherein the at least one processor is further configured to:
create one of the at least one piece of ID information based on the multiple pieces of bio-information.

8. The electronic device of claim 1, wherein the at least one piece of first bio-information includes at least one of fingerprint information, iris information, face information, heart rate information, voice information, or blood vessel information.

9. The electronic device of claim 1, wherein the at least one key value is set based on a seed value which is stored in the memory and is identical to a seed value of the at least one external device.

10. The electronic device of claim 1, wherein the at least one parameter value is set to include at least one of time information or location information of the electronic device.

11. A method of authenticating a user by an electronic device, the method comprising:
acquiring at least one piece of first bio-information related to a part of a body of the user through a sensor;
creating at least one piece of identification (ID) information based on the at least one piece of the first bio-information;
setting at least one of at least one key value or at least one parameter value used for generating at least one one-time password (OTP) by using the at least one piece of ID information;
generating the at least one OTP by using the at least one key value and the at least one parameter value; and
transmitting the at least one OTP to at least one external device.

12. The method of claim 11,
wherein the creating of the at least one piece of ID information includes creating multiple pieces of ID information based on one of the at least one piece of first bio-information,
wherein the generating of the at least one OPT includes generating OTPs which are mutually different by using each of the multiple pieces of ID information, and
wherein the transmitting of the at least one OTP to the at least one external device includes transmitting each of the OTPs to external devices which are different from each other.

13. The method of claim 12, wherein the creating of the multiple pieces of ID information includes variously setting a type of an algorithm used in creating the at least one piece of ID information or a number of times that the algorithm is applied.

14. The method of claim 11,
wherein the acquiring of the at least one piece of first bio-information includes acquiring multiple pieces of bio-information, and
wherein the creating of the at least one piece of ID information includes creating one of the at least one piece of ID information based on the multiple pieces of bio-information.

15. The method of claim 11, wherein the setting of the at least one of the at least one key value or the at least one parameter value includes setting the at least one key value based on a seed value which is stored in a memory and is identical to a seed value of the at least one external device.

16. The method of claim 11, wherein the setting of the at least one of the at least one key value or the at least one parameter value includes setting the at least one parameter value to include at least one of time information or location information of the electronic device.

17. An electronic device comprising:
a housing:
a display that is exposed through one surface of the housing;
a biometric sensor mounted in a portion of the housing;
a wireless communication circuit;
at least one processor electrically connected with the display, the biometric sensor, and the wireless communication circuit; and
a memory electrically connected with the processor and configured to store bio-information of a user,
wherein the memory stores instructions that, when executed, cause the at least one processor to:
acquire first bio-information of the user by using the biometric sensor,
compare the first bio-information with second bio-information which is stored in the memory,
select or create first information based on a comparison result,
generate a number based on the first information, second information related to the electronic device, and time information,
transmit the number to an external server through the wireless communication circuit, and
receive a response related to the number from the external server through the wireless communication circuit.

18. The electronic device of claim 17, wherein the first information includes an identification (ID) number.

19. The electronic device of claim 17, wherein the second information includes at least one of a serial number or a phone number of the electronic device.

20. The electronic device of claim 17, wherein the bio-information is stored in a security area.
